(19) United States
(12) Patent Application Publication
(10) Pub. No.: US 2024/0309297 A1
(43) Pub. Date: Sep. 19, 2024

(54) ALKOXIDE-BASED SOLIDIFICATION VIA CONTROL OF REACTION EQUILIBRIUM AND KINETICS

(71) Applicant: ECOLAB USA INC., Saint Paul, MN (US)

(72) Inventors: Victor Fuk-Pong Man, Saint Paul, MN (US); Clinton Hunt, JR., Saint Paul, MN (US); Gang Pu, Saint Paul, MN (US); Derrick Anderson, Saint Paul, MN (US); Kelly Anne Rightmire, Saint Paul, MN (US); Corey Rosenthal, Saint Paul, MN (US)

(21) Appl. No.: 18/606,681

(22) Filed: Mar. 15, 2024

Related U.S. Application Data
(60) Provisional application No. 63/490,838, filed on Mar. 17, 2023.

(51) Int. Cl. C11D 3/04; C11D 3/10; C11D 17/04

(52) U.S. Cl. CPC C11D 3/044; C11D 3/10; C11D 17/044

(57) ABSTRACT

Solid compositions and methods of making solids for various applications of use are provided. Liquid caustic is reacted with an organic molecule having at least one hydroxyl group, alkylene carbonates, and the like, to provide a solid caustic composition that is a contiguous solid. The compositions and methods reduce or eliminate the use of caustic beads (100% NaOH) in solid caustic compositions.

### CROSS REFERENCE TO RELATED APPLICATIONS

This application claims priority under 35 U.S.C. § 119 to provisional application Ser. No. 63/490,838, filed Mar. 17, 2023, herein incorporated by reference in its entirety.

### FIELD OF THE DISCLOSURE

The present disclosure relates to the field of solid compositions for various applications of use. In some embodiments, a caustic source is provided in combination with an organic molecule having at least one hydroxyl group, such as glycols, amino alcohols, alkylene carbonates, and the like, to provide a solid composition with a caustic:water weight ratio from about 27:73 to about 75:25, or from about 50:50 to about 75:25 in some embodiments. In other aspects, the solid compositions can reduce or eliminate the use of other solidifying agents including costly solid hydroxide beads commonly used to make solid caustic compositions for use in cleaning, sanitizing, and disinfecting.

### BACKGROUND

The background description provided herein gives context for the present disclosure. Work of the presently named inventors, as well as aspects of the description that may not otherwise qualify as prior art at the time of filing, are neither expressly nor impliedly admitted as prior art.

Alkali metal hydroxides, commonly referred to as caustic, is commonly sold in solid form (e.g. pellets, flakes, blocks) and is frequently used in manufacturing processes. The manufacturing of caustic beads is energy intensive and compositions containing caustic beads are generally hygroscopic. Additionally, there are safety concerns surrounding the transportation and handling of other strong bases, such as alkoxides. Alkoxides are strong bases which readily decompose tissues and proteins when contacted and further are unstable in water, making storage and transportation difficult in the certain weather conditions or in the event moisture is present in the storage container.

Despite these challenges of using solid caustic and alkoxides there remains advantages to using solid compositions, such as caustic cleaning compositions. For example, storing and transporting of solid concentrates are less expensive than the storage and transporting of liquids. There are also fewer safety and stability challenges associated with transporting and handling of solid compositions.

Therefore, it is an object of the disclosure to provide novel solid compositions and methods of making the solid compositions which provide cost effective alternatives to the purchase of solid caustic to incorporate into a solid composition.

Accordingly, it is an objective of the claimed disclosure to develop solid compositions that provide a contiguous solid suitable for use in various solid compositions.

It is an objective to develop solid compositions that can be pre-formed and used in various solidification processes (e.g. pressed, cast, extruded) and/or can be used to form a solid in situ or at a point of use.

It is a further objective to develop solid compositions that minimize the use of solid caustic beads required to make caustic solid compositions.

It is a further object of the disclosure to provide methods for converting caustic liquid into an alkoxide for use in various solid compositions. Methods can include in situ generation or preforming solid complexes (e.g. dehydrated binding agents) to be used in forming a solid composition.

Other objects, advantages and features of the present disclosure will become apparent from the following specification taken in conjunction with the accompanying drawings.

### BRIEF SUMMARY OF THE DISCLOSURE

The following objects, features, advantages, aspects, and/or embodiments, are not exhaustive and do not limit the overall disclosure. No single embodiment need provide each and every object, feature, or advantage. Any of the objects, features, advantages, aspects, and/or embodiments disclosed herein can be integrated with one another, either in full or in part.

The compositions according to the disclosure provide solid compositions and methods of producing the same. Methods of solidifying hydroxide to form contiguous solids suitable for use in various solid compositions are also included in the embodiments of the disclosure.

In embodiments solid compositions comprise: an alkali metal hydroxide; an organic molecule having at least one hydroxyl group; and water; wherein the weight ratio of the alkali metal hydroxide to water in the solid composition is from about 27:73 to about 75:25, and wherein the composition is a contiguous solid, powder or granule.

In embodiments, methods of forming solid compositions comprise: mixing the organic molecule containing at least one hydroxyl group with a liquid alkali metal hydroxide; and either (a) forming in situ a contiguous solid composition or (b) isolating the solid as a precipitate material, wherein the molar ratio of the alkali metal hydroxide to polyol is between about 1:1 and about 10:1.

In further embodiments, solid compositions comprise: an alkali metal hydroxide and/or an alkali metal carbonate; an alkylene carbonate; and water; wherein the molar ratio of the initial alkali metal hydroxide to alkylene carbonate combined to make the solid composition is from about 0.5:1 to about 10:1, and wherein the composition is a contiguous solid, powder or granule.

In further embodiments, methods of forming the solid compositions as described herein comprise: mixing the alkylene carbonate with a liquid alkali metal hydroxide; and either (a) forming in situ a contiguous solid composition or (b) isolating the solid as a precipitate material, wherein the molar ratio of the initial alkali metal hydroxide to alkylene carbonate is from about 0.5:1 to 10:1.

In additional embodiments, methods of using the solid compositions as described herein for cleaning, disinfecting, and/or sanitizing comprise: contacting an article or surface in need of cleaning, disinfecting, and/or sanitizing with any of the solid compositions described herein; and cleaning, disinfecting, and/or sanitizing the article or surface. While multiple embodiments are disclosed, still other embodiments of the present disclosure will become apparent to those skilled in the art from the following detailed description, which shows and describes illustrative embodiments of the disclosure. Accordingly, the drawings and detailed description are to be regarded as illustrative in nature and not restrictive.

### BRIEF DESCRIPTION OF THE DRAWINGS

FIG. 1A shows results of evaluated solid caustic solid compositions (Formulas 3-4) compared to Commercial Product A in machine ware washing test using unstained ware as described in the Examples.

FIG. 1B shows results of evaluated solid caustic solid compositions (Formulas 3-4) compared to Commercial Product A in machine ware washing tests using stained ware as described in the Examples.

FIG. 2 shows results of evaluated solid caustic compositions (Formulas 3-5) compared to Commercial Product A in machine ware washing tests as described in the Examples.

FIG. 3 shows results of evaluated solid caustic compositions (Formulas 3-4) compared to Commercial Product A in machine ware washing tests as described in the Examples.

Various embodiments will be described in detail with reference to the drawings, wherein like reference numerals represent like parts throughout the several views. Reference to various embodiments does not limit the scope of the invention. Figures represented herein are not limitations to the various embodiments according to the invention and are presented for exemplary illustration of the invention.

### DETAILED DESCRIPTION OF THE PREFERRED EMBODIMENT

The embodiments of this disclosure are not limited to particular solid compositions containing the alkoxide binding agents, methods of making and/or methods of employing the same for hard surface sanitizing and disinfecting, including antimicrobial and/or sanitizing application for cleaning compositions, along with alternative cleaning and uses for cleaning compositions, which can vary and are understood by skilled artisans. So that the disclosure may be more readily understood, certain terms are first defined. It is further to be understood that all terminology used herein is for the purpose of describing particular embodiments only, and is not intended to be limiting in any manner or scope. For example, as used in this specification and the appended claims, the singular forms “a,” “an” and “the” can include plural referents unless the content clearly indicates otherwise. Further, all units, prefixes, and symbols may be denoted in its SI accepted form.

Numeric ranges recited within the specification are inclusive of the numbers defining the range and include each integer within the defined range. Throughout this disclosure, various aspects of this disclosure are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges, fractions, and individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6, and decimals and fractions. This applies regardless of the breadth of the range.

So that the present disclosure may be more readily understood, certain terms are first defined. Unless defined otherwise, all technical and scientific terms used herein have the same meaning as commonly understood by one of ordinary skill in the art to which embodiments of the disclosure pertain. Many methods and materials similar, modified, or equivalent to those described herein can be used in the practice of the embodiments of the present disclosure without undue experimentation, the preferred materials and methods are described herein. In describing and claiming the embodiments of the present disclosure, the following terminology will be used in accordance with the definitions set out below.

As used herein, the term “and/or”, e.g., “X and/or Y” shall be understood to mean either “X and Y” or “X or Y” and shall be taken to provide explicit support for both meanings or for either meaning, e.g. A and/or B includes the options i) A, ii) B or iii) A and B.

Unless defined otherwise, all technical and scientific terms used above have the same meaning as commonly understood by one of ordinary skill in the art to which embodiments of the present disclosure pertain.

The term “about,” as used herein, refers to variation in the numerical quantity that can occur, for example, through typical measuring techniques and equipment, with respect to any quantifiable variable, including, but not limited to, concentration, mass, volume, time, molecular weight, temperature, pH, humidity, molar ratios, log count of bacteria or viruses, and the like. Further, given solid and liquid handling procedures used in the real world, there is certain inadvertent error and variation that is likely through differences in the manufacture, source, or purity of the ingredients used to make the compositions or carry out the methods and the like. The term “about” also encompasses these variations. Whether or not modified by the term “about,” the claims include equivalents to the quantities.

The term “actives” or “percent actives” or “percent by weight actives” or “actives concentration” are used interchangeably herein and refers to the concentration of those ingredients involved in cleaning expressed as a percentage minus inert ingredients such as water or salts.

As used herein, the term “alkoxide” refers to a conjugate base of an organic molecule having one or more hydroxyl groups and can be formed through the deprontonation of the hydroxyl group(s), which is a weak acid/base reaction.

As used herein, the term “alkyl” or “alkyl groups” refers to saturated hydrocarbons having one or more carbon atoms, including straight-chain alkyl groups (e.g., methyl, ethyl, propyl, butyl, pentyl, hexyl, heptyl, octyl, nonyl, decyl, etc.), cyclic alkyl groups (or “cycloalkyl” or “alicyclic” or “carbocyclic” groups) (e.g., cyclopropyl, cyclopentyl, cyclohexyl, cycloheptyl, cyclooctyl, etc.), branched-chain alkyl groups (e.g., isopropyl, tert-butyl, sec-butyl, isobutyl, etc.), and alkyl-substituted alkyl groups (e.g., alkyl-substituted cycloalkyl groups and cycloalkyl-substituted alkyl groups).

Unless otherwise specified, the term “alkyl” includes both “unsubstituted alkyls” and “substituted alkyls.” As used herein, the term “substituted alkyls” refers to alkyl groups having substituents replacing one or more hydrogens on one or more carbons of the hydrocarbon backbone. Such substituents may include, for example, alkenyl, alkynyl, halogeno, hydroxyl, alkylcarbonyloxy, arylcarbonyloxy, alkoxycarbonyloxy, aryloxy, aryloxycarbonyloxy, carboxylate, alkylcarbonyl, arylcarbonyl, alkoxycarbonyl, aminocarbonyl, alkylaminocarbonyl, dialkylaminocarbonyl, alkylthiocarbonyl, alkoxyl, phosphate, phosphonato, phosphinato, cyano, amino (including alkyl amino, dialkylamino, arylamino, diarylamino, and alkylarylamino), acylamino (including alkylcarbonylamino, arylcarbonylamino, carbamoyl and ureido), imino, sulfhydryl, alkylthio, arylthio, thiocarboxylate, sulfates, alkylsulfinyl, sulfonates, sulfamoyl, sulfonamido, nitro, trifluoromethyl, cyano, azido, heterocyclic, alkylaryl, or aromatic (including heteroaromatic) groups.

As used herein, the term “antimicrobial” refers to a compound or composition that reduces and/or inactivates a microbial population, including, but not limited to bacteria, viruses, fungi, and algae within about 10 minutes or less, about 8 minutes or less, about 5 minutes or less, about 3 minutes or less, about 2 minutes or less, about 1 minute or less, or about 30 seconds or less. Preferably, the term antimicrobial refers to a composition that provides at least about a 3-log, 3.5 log, 4 log, 4.5 log, or 5 log reduction of a microbial population in about 10 minutes or less, about 8 minutes or less, about 5 minutes or less, about 3 minutes or less, about 2 minutes or less, about 1 minute or less, or about 30 seconds or less.

As used herein, the term “cleaning” refers to a method used to facilitate or aid in soil removal, bleaching, microbial population reduction, and any combination thereof.

As used herein, the term “disinfectant” refers to an agent that kills all vegetative cells including most recognized pathogenic microorganisms, using the procedure described in A.O.A.C. Use Dilution Methods, Official Methods of Analysis of the Association of Official Analytical Chemists, paragraph 955.14 and applicable sections, 15th Edition, 1990 (EPA Guideline 91-2). According to this reference a disinfectant should provide a 99.999% reduction (5-log order reduction) within 30 seconds at room temperature, 25±2° C., against several test organisms. According to embodiments of the disclosure, a disinfecting composition provides a 99.999% reduction (5-log order reduction) of the desired organisms (including bacterial contaminants) at a use temperature. Further, a disinfectant should provide a 99.99% reduction (4-log order reduction) within 30 seconds at room temperature, 25±2° C., against several test organisms. According to embodiments of the disclosure, a disinfecting composition provides a 99.99% reduction (4-log order reduction) of the desired organisms (including bacterial contaminants) at a use temperature. Further, a disinfectant should provide a 99.9% reduction (3-log order reduction) within 30 seconds at room temperature, 25±2° C., against several test organisms. According to embodiments of the disclosure, a disinfecting composition provides a 99.9% reduction (3-log order reduction) of the desired organisms (including bacterial contaminants) at a use temperature. As used herein, the term “high level disinfection” or “high level disinfectant” refers to a compound or composition that kills substantially all organisms, except high levels of bacterial spores, and is affected with a chemical germicide cleared for marketing as a sterilant by the Food and Drug Administration. As used herein, the term “intermediate-level disinfection” or “intermediate level disinfectant” refers to a compound or composition that kills mycobacteria, most viruses, and bacteria with a chemical germicide registered as a tuberculocide by the Environmental Protection Agency (EPA). As used herein, the term “low-level disinfection” or “low level disinfectant” refers to a compound or composition that kills some viruses and bacteria with a chemical germicide registered as a hospital disinfectant by the EPA.

As used herein, the term “exemplary” refers to an example, an instance, or an illustration, and does not indicate a most preferred embodiment unless otherwise stated.

As used herein, the phrase “food processing surface” refers to a surface of a tool, a machine, equipment, a structure, a building, or the like that is employed as part of a food processing, preparation, or storage activity. Examples of food processing surfaces include surfaces of food processing or preparation equipment (e.g., slicing, canning, or transport equipment, including flumes), of food processing wares (e.g., utensils, dishware, wash ware, and bar glasses), and of floors, walls, or fixtures of structures in which food processing occurs. Food processing surfaces are found and employed in food anti-spoilage air circulation systems, aseptic packaging sanitizing, food refrigeration and cooler cleaners and sanitizers, ware washing sanitizing, blancher cleaning and sanitizing, food packaging materials, cutting board additives, third-sink sanitizing, beverage chillers and warmers, meat chilling or scalding waters, autodish sanitizers, sanitizing gels, cooling towers, food processing antimicrobial garment sprays, and non-to-low-aqueous food preparation lubricants, oils, and rinse additives.

As used herein, the phrase “food product” includes any food substance that might require treatment with an antimicrobial agent or composition and that is edible with or without further preparation. Food products include meat (e.g. red meat and pork), seafood, poultry, produce (e.g., fruits and vegetables), eggs, living eggs, egg products, ready to eat food, wheat, seeds, roots, tubers, leaves, stems, corns, flowers, sprouts, seasonings, or a combination thereof. The term “produce” refers to food products such as fruits and vegetables and plants or plant-derived materials that are typically sold uncooked and, often, unpackaged, and that can sometimes be eaten raw.

The term “generally” encompasses both “about” and “substantially.”

The term “hard surface” refers to a solid, substantially non-flexible surface such as a countertop, tile, floor, wall, panel, window, plumbing fixture, kitchen and bathroom furniture, appliance, engine, circuit board, and dish. Hard surfaces may include for example, health care surfaces and food processing surfaces.

As used herein, the phrase “health care surface” refers to a surface of an instrument, a device, a cart, a cage, furniture, a structure, a building, or the like that is employed as part of a health care activity. Examples of health care surfaces include surfaces of medical or dental instruments, of medical or dental devices, of electronic apparatus employed for monitoring patient health, and of floors, walls, or fixtures of structures in which health care occurs. Health care surfaces are found in hospital, surgical, infirmity, birthing, mortuary, and clinical diagnosis rooms. These surfaces can be those typified as “hard surfaces” (such as walls, floors, bed-pans, etc.), or fabric surfaces, e.g., knit, woven, and non-woven surfaces (such as surgical garments, draperies, bed linens, bandages, etc.,), or patient-care equipment (such as respirators, diagnostic equipment, shunts, body scopes, wheel chairs, beds, etc.,), or surgical and diagnostic equipment. Health care surfaces include articles and surfaces employed in animal health care.

As used herein, the term “instrument” refers to the various medical or dental instruments or devices that can benefit from cleaning with a composition according to the present disclosure.

The terms “invention” or “present invention” are not intended to refer to any single embodiment of the particular invention but encompass all possible embodiments as described in the specification and the claims.

As used herein, the phrases “medical instrument,” “dental instrument,” “medical device,” “dental device,” “medical equipment,” or “dental equipment” refer to instruments, devices, tools, appliances, apparatus, and equipment used in medicine or dentistry. Such instruments, devices, and equipment can be cold sterilized, soaked or washed and then heat sterilized, or otherwise benefit from cleaning in a composition of the present disclosure. These various instruments, devices and equipment include, but are not limited to: diagnostic instruments, trays, pans, holders, racks, forceps, scissors, shears, saws (e.g. bone saws and their blades), hemostats, knives, chisels, rongeurs, files, nippers, drills, drill bits, rasps, burrs, spreaders, breakers, elevators, clamps, needle holders, carriers, clips, hooks, gouges, curettes, retractors, straightener, punches, extractors, scoops, keratomes, spatulas, expressors, trocars, dilators, cages, glassware, tubing, catheters, cannulas, plugs, stents, scopes (e.g., endoscopes, stethoscopes, and arthroscopes) and related equipment, and the like, or combinations thereof.

As used herein, the term “microbe” is synonymous with microorganism. For the purpose of this patent application, successful microbial reduction is achieved when the microbial populations are reduced by at least about 50%, or by significantly more than is achieved by a wash with water. Larger reductions in microbial population provide greater levels of protection. Differentiation of antimicrobial “-cidal” or “-static” activity, the definitions which describe the degree of efficacy, and the official laboratory protocols for measuring this efficacy are considerations for understanding the relevance of antimicrobial agents and compositions. Cleaning compositions can affect two kinds of microbial cell damage. The first is a lethal, irreversible action resulting in complete microbial cell destruction or incapacitation. The second type of cell damage is reversible, such that if the organism is rendered free of the agent, it can again multiply. The former is termed microbiocidal and the later, microbiostatic. A sanitizer and a disinfectant are, by definition, agents which provide antimicrobial or microbiocidal activity. In contrast, a preservative is generally described as an inhibitor or microbiostatic composition.

As used herein, the term “microorganism” refers to any noncellular or unicellular (including colonial) organism. Microorganisms include all prokaryotes. Microorganisms include bacteria (including cyanobacteria), spores, lichens, fungi, protozoa, virinos, viroids, viruses, phages, and some algae. As used herein, the term “microbe” is synonymous with microorganism. For the purpose of this patent application, successful microbial reduction is achieved when the microbial populations are reduced by at least about 50%, or by significantly more than is achieved by a wash with water. Larger reductions in microbial population provide greater levels of protection.

As used herein the term “polymer” refers to a molecular complex comprised of a more than ten monomeric units and generally includes, but is not limited to, homopolymers, copolymers, such as for example, block, graft, random and alternating copolymers, terpolymers, and higher “x”mers, further including their analogs, derivatives, combinations, and blends thereof. Furthermore, unless otherwise specifically limited, the term “polymer” shall include all possible isomeric configurations of the molecule, including, but are not limited to isotactic, syndiotactic and random symmetries, and combinations thereof. Furthermore, unless otherwise specifically limited, the term “polymer” shall include all possible geometrical configurations of the molecule.

As used herein, the term “sanitizer” refers to an agent that reduces the number of bacterial contaminants to safe levels as judged by public health requirements. In an embodiment, sanitizers for use in this disclosure will provide at least a 99.999% reduction (5-log order reduction). These reductions can be evaluated using a procedure set out in Germicidal and Detergent Sanitizing Action of Disinfectants, Official Methods of Analysis of the Association of Official Analytical Chemists, paragraph 960.09 and applicable sections, 15th Edition, 1990 (EPA Guideline 91-2). According to this reference a sanitizer should provide a 99.999% reduction (5-log order reduction) within 30 seconds at room temperature, 25±2° C., against several test organisms. According to embodiments of the disclosure, a sanitizing composition provides a 99.999% reduction (5-log order reduction) of the desired organisms (including bacterial contaminants) at a use temperature. Further, a sanitizer should provide a 99.99% reduction (4-log order reduction) within 30 seconds at room temperature, 25±2° C., against several test organisms. According to embodiments of the disclosure, a sanitizing composition provides a 99.99% reduction (4-log order reduction) of the desired organisms (including bacterial contaminants) at a use temperature. Further, a sanitizer should provide a 99.9% reduction (3-log order reduction) within 30 seconds at room temperature, 25±2° C., against several test organisms. According to embodiments of the disclosure, a sanitizing composition provides a 99.9% reduction (3-log order reduction) of the desired organisms (including bacterial contaminants) at a use temperature.

The “scope” of the present disclosure is defined by the appended claims, along with the full scope of equivalents to which such claims are entitled. The scope of the disclosure is further qualified as including any possible modification to any of the aspects and/or embodiments disclosed herein which would result in other embodiments, combinations, subcombinations, or the like that would be obvious to those skilled in the art.

As used herein, the term “substantially free” refers to compositions completely lacking the component or having such a small amount of the component that the component does not affect the effectiveness of the composition. The component may be present as an impurity or as a contaminant and shall be less than 0.5 wt. %. In another embodiment, the amount of the component is less than 0.1 wt. % and in yet another embodiment, the amount of component is less than 0.01 wt. %.

The term “surfactant” as used herein is a compound that contains a lipophilic

segment and a hydrophilic segment, which when added to water or solvents, reduces the surface tension of the system.

As used herein, the term “ware” refers to items such as eating and cooking utensils, dishes, and other hard surfaces such as showers, sinks, toilets, bathtubs, countertops, windows, mirrors, transportation vehicles, and floors. As used herein, the term “ware washing” refers to washing, cleaning, or rinsing ware. Ware also refers to items made of plastic. Types of plastics that can be cleaned with the compositions according to the disclosure include but are not limited to, those that include polycarbonate polymers (PC), acrilonitrile-butadiene-styrene polymers (ABS), and polysulfone polymers (PS). Another exemplary plastic that can be cleaned using the compounds and compositions of the disclosure include polyethylene terephthalate (PET).

As used herein, “weight percent,” “wt-%,” “percent by weight,” “% by weight,” and variations thereof refer to the concentration of a substance as the weight of that substance divided by the total weight of the composition and multiplied by 100. It is understood that, as used here, “percent,” “%,” and the like are intended to be synonymous with “weight percent,” “wt-%,” etc.

The solid compositions, methods of making the compositions, and methods of use of the present disclosure may comprise, consist essentially of, or consist of the components and ingredients of the present disclosure as well as other ingredients described herein. As used herein, “consisting essentially of” means that the methods and compositions may include additional steps, components or ingredients, but only if the additional steps, components or ingredients do not materially alter the basic and novel characteristics of the claimed methods and compositions.

### Solid Compositions

The solid compositions are a contiguous solid, powder or granule comprising an alkali metal hydroxide (i.e. at least one caustic source), at least one organic molecule having one or more hydroxyl-groups or an alkylene carbonate, and water.

The solid compositions are simplified to show the caustic species and water in the solid composition as depicted by the following (which are not indicative of equimolar amounts of each component): alkoxide·alkali·nH₂O where n is from 0 to 10, 0.5 to 10, 1 to 10, or preferably 1-2, a monocationic alkoxide such as monosodium glycoxide·NaOH·nH₂O where n is from 0 to 10, 0.5 to 10, 1 to 10, or preferably 1-2, or monocationic alkoxide such as monosodium glycerolate·NaOH·nH₂O where n is from 0 to 10, 0.5 to 10, 1 to 10, or preferably 1-2. As referred to herein, monocationic alkoxides can include any mono alkaline earth metal alkoxides, such as monosodium alkoxide, monopotassium alkoxide, or other Group 1 metals.

As disclosed herein, the solid is contiguous, meaning that the solid hydrates that make up the solid composition where the E-form hydrates are adjacent to one another in the solid. The contiguous solid composition forms as a result of the alkoxide·alkali·nH₂O sharing water molecule throughout the solid composition.

In an aspect, the solid compositions after reaction with a polyol (e.g. glycols) and solidification comprise, consist of, and/or consist essentially of (alkoxide)(alkali)ₘ(H₂O)ₙ, where the molar ratio of m and n are equivalent having a 1:1 molar ratio, or (alkoxide)(NaOH)ₘ(H₂O), where the molar ratio of m and n are equivalent having a 1:1 molar ratio of caustic to water, or from about 1:2.2 to about 1:1 molar ratio of caustic to water. The caustic:water molar ratios in the solid composition can be calculated through molecular weights as well as analytically confirmed by an acid/base titration that determines active alkalinity along with analytical calculation for water content, such as with the Karl Fischer method or TGA (Thermal Gravimetric Analysis).

In an aspect, the solid compositions after reaction with a polyol have a weight ratio of the alkali metal hydroxide to water in the solid composition from about 27:73 to about 75:25, from about 50:50 to about 75:25, or from about 60:40 to about 70:30, wherein the water refers to the total water content in the solid composition from any component and/or water added as a raw material. The caustic:water weight ratios in the solid composition can be calculated as well as analytically confirmed by an acid/base titration that determines active alkalinity along with analytical calculation for water content, such as with the Karl Fischer method or TGA (Thermal Gravimetric Analysis).

Without being limited according to a particular mechanism of action, the methods of making the solid compositions are different from conventional caustic solids containing both solid caustic (e.g. beads) and/or caustic with an ash source along with a solid alkoxide as there is no solidification of both alkalinity sources into hydrate solids. The disclosed compositions and methods provides solidification of caustic (and could also include carbonate) can be achieved simultaneously and in the same contiguous solid composition. These differ from conventional caustic solids in having a weight ratio of caustic:water in the formed solid that is lower, including below 75:25, and preferably 70:30. These also differ in having distinct hydrate solids are formed which can be quantified by distinct melting bands, which is unlike other solids containing solid caustic monohydrate (single sharp melting point of 66° C.) and ash monohydrate (single melting point of 100° C.) where one can interfere with the solidification of the other as observed by failing to form a contiguous solid due to a liquid alkalinity source interfering with solidification. The distinct increase in melting peaks confirms the different solidification structure for the solid compositions having the lower caustic to water ratio in the formed solids. The increased melting point also is beneficial and further demonstrate the ability to solidify compositions having increased water content without the solid becoming too softened or losing its shape.

The solid compositions are also dimensionally stable. The solid compositions are considered to exhibit dimensional stability if the measured dimensions as dependent upon the shape of the solid (e.g. combined diameter and height) swelling or growth is less than approximately 3%, and particularly less than approximately 2%. The time and temperature conditions for the measurement of dimensional stability can be at 4 weeks in an oven, wherein the oven is an environmental chamber between about 40° C.-50° C. and about 65% relative humidity.

The solid compositions comprise the alkali metal hydroxide, organic molecule having at least one hydroxyl group (e.g. polyol) or alkylene carbonate, and water. The solid compositions can further comprise at least one additional functional ingredient. Exemplary ranges of the reagents to make the solid compositions according to the disclosure are shown in Tables 1A-1C each in weight percentage. For purposes of the Tables below the simplified term “polyol” is used, however also includes the scope of the broader description contained herein of organic molecules having at least one hydroxyl group (i.e. includes polyols).

TABLE 1A

| | First Exemplary | Second Exemplary | Third Exemplary |
|---|---|---|---|
| Material | Range wt.-% | Range wt.-% | Range wt.-% |
| Alkali metal | 10-99 | 20-90 | 50-90 |
| hydroxide | | | |
| Polyol or Alkylene | 1-20 | 1-15 | 1-10 |
| Carbonate | | | |
| Additional | 0-80 | 2-60 | 5-50 |
| Functional | | | |
| Ingredients | | | |
| Total | 100 | 100 | 100 |

TABLE 1B

| | First Exemplary | Second Exemplary | Third Exemplary |
|---|---|---|---|
| Material | Range wt.-% | Range wt.-% | Range wt.-% |
| Alkali metal | 10-99 | 20-90 | 50-90 |
| hydroxide | | | |
| Polyol or Alkylene | 1-20 | 1-15 | 1-10 |
| Carbonate | | | |
| Surfactant(s) | 0-40 | 1-20 | 1-10 |
| Additional | 0-80 | 0-60 | 0-50 |
| Functional | | | |
| Ingredients | | | |
| Total | 100 | 100 | 100 |

TABLE 1C

| | First Exemplary | Second Exemplary | Third Exemplary |
|---|---|---|---|
| Material | Range wt.-% | Range wt.-% | Range wt.-% |
| Alkali metal | 10-99 | 20-90 | 50-90 |
| hydroxide | | | |
| Polyol or Alkylene | 1-20 | 1-15 | 1-10 |
| Carbonate | | | |
| Additional alkaline | 0-60 | 1-50 | 10-50 |
| carrier | | | |
| Surfactant(s) | 0-40 | 1-20 | 1-10 |
| Additional | 0-80 | 0-60 | 0-50 |
| Functional | | | |
| Ingredients | | | |
| Total | 100 | 100 | 100 |

In an embodiment, the compositions have between about 10% and about 100%, at least about 10%, at least about 20%, at least about 30%, at least about 40%, at least about 50%, at least about 60%, at least about 70%, at least about 80%, or at least about 90% reduction in solid caustic (e.g. caustic beads). In some embodiments, the solid compositions include alkali metal hydroxide wherein less than about 40 wt-% of the alkali metal hydroxide is from a solid caustic bead. In some embodiments, the alkali metal hydroxide of the solid compositions is free of solid caustic beads.

In embodiments the alkalinity source in the final composition (including alkalinity and/or neutralization from additional components in the composition) provides a total alkalinity as measured by percent of Na2O is from about 20-47%, from about 25-40%, or preferably from about 28-37%. In embodiments the total alkalinity as measured by percent of Na2O is from about 20-47%, from about 25-40%, or preferably from about 28-37%, has more alkalinity provided by carbonate alkalinity source compared to caustic alkalinity source. Total alkalinity can measure alkalinity from various sources in addition to sodium hydroxide, including less alkalinity sources such as, for example, sodium bicarbonate. The total alkalinity is measured by standard acid-based titration using HCl in a liquid or in a solid dissolved in water to generate a liquid.

In some embodiments the alkalinity source in the final composition is less than about 70:30 alkali metal hydroxide to water weight ratio to provide improved cleaning performance in comparison to compositions comprising additional alkali metal hydroxide.

### Methods of Making Solid Compositions

The solid compositions are prepared by addition of materials. Without seeking to be limited to a particular theory of the disclosure, when the components of the composition are combined, the formation of high moles of solid hydrates occur as follows from reacting a hydroxyl-containing organic molecule with a caustic source: R—OH+NaOH→R—O⁻Na⁺+H₂O, wherein R—OH is an organic molecule with one or more hydroxyl groups, or an alkylene carbonate. The formation of water is shared as monohydrate with surrounding caustic (notably any caustic source can be employed and is not limited to the depicted sodium hydroxide source in the depicted reaction). Without being limited to a particular mechanism of action, the generated sodium alkoxide is a type of solid caustic species that provides a contiguous solid block, or a substantially homogeneous semi-solid mixture in which the components are distributed throughout its mass.

In most embodiments, the methods of making the solid caustic compositions are equilibrium, non-stoichiometric reactions (R—OH+NaOH→R—O⁻Na⁺+H₂O). The reagents for non-stoichiometric reactions include the organic molecules having at least one hydroxyl group. The resultant solids are alkoxides such as glycoxides, including monosodium ethylene glycoxide, monosodium propylene glycoxide, monosodium butylene glycoxide, and monosodium glycerolate. The solid compositions when dissolved revert back to the starting reagents in equilibrium and can be quantitatively measured to show the starting materials.

In embodiments employing an alkylene carbonate reagent, the methods of making the solid compositions are stoichiometric reactions producing the solid alkoxide and carbon dioxide (R—OH+NaOH→R—O⁻Na⁺+CO₂). The stoichiometric reactions can beneficially drive the reaction to completion with the generation of the solid caustic species and less moles of water than a non-stoichiometric reaction due to the byproduct of carbon dioxide. In some embodiments, the byproduct of carbon dioxide remains in the solid system as an acidic component; the trapped carbon dioxide, together with other acidic ingredients such as for example, acidic forms of water conditioning polymers and chelants, can neutralize and exhaust the caustic as well as the alkoxide, and form bicarbonate. If present, sodium carbonate in a composition can further react the bicarbonate to solidify through sesquicarbonate dihydrate formation. As referred to in the composition claims formed by reacting an alkali metal hydroxide with an alkylene carbonate, alkali metal carbonate can further include or be replaced with sesquicarbonate depending on the extend of the reaction of bicarbonate with sodium carbonate.

The reactions provide in situ generation of the solid compositions which are contiguous solid compositions, powders or granules.

In still further embodiments the in-situ generation can include making solid compositions comprising at least one additional functional ingredient, wherein the composition is solidified in situ. The methods of solidifying a composition can include combining the liquid caustic source with one or more organic molecules containing at least one hydroxyl group, or an alkylene carbonate, along with combining at least one additional functional ingredient, and solidifying to form the solid composition. In preferred embodiments, the components reacted to form the solid composition are transferred into a container or housing before the solidification (e.g. capsule for dispensing). Beneficially, in embodiments the methods of solidifying do not require a step of chilling the composition to lower the temperature below a solidification temperature, a significant benefit over commercial caustic bead-based solid compositions.

In other embodiments, the reaction can form the solid compositions where solids are isolated as a precipitate material for further use. Such further use may include a dehydration step to remove water. Such isolated and dehydrated solids are suitable for use in a solid composition or as a pre-mix. An exemplary application of use of a dehydrated solid would be for use in forming pressed solid compositions.

In some aspects, the compositions can be made by combining the components in an aqueous diluent using commonly available containers and blending apparatus. Beneficially, no special manufacturing equipment is required for making the compositions. A preferred method for manufacturing the solid compositions of the disclosure includes introducing the components into a stirred production vessel.

In a method according to the disclosure, a composition is formed by mixing the reagents to form in situ a solid or to form precipitate, and isolating the precipitates for further use. In such an embodiment, the solids can be further processed for use, such as for example spray drying the solid material, utilizing a fluid bed dryer, and/or through granulation.

Spray drying is typically a one step process where a liquid is dried with hot gas and the resulting particles are often finer and do not have the opportunity to agglomerate or grow in size before reaching the product outlet.

In some embodiments where larger particles are desired, a fluid bed can be integrated into the process. In fluid bed drying, a liquid is dried with hot gas and the resulting particles have the opportunity to recirculate through the spray zone enabling agglomeration or layered growth of the particles to a desired size. Particles of these sizes are often referred to as granulates. Granulation is a broader term where through various methods or pieces of equipment, a finer powder is grown into granulates. Fluid bed granulation is a type of granulation.

In an embodiment, the dried material is a powder or granule form of the solid. This beneficially provides a dust-free, free-flowing granule or powder. In an exemplary embodiment, the solidification reaction is completed in an aqueous solution and then dried (e.g. through spray drying, fluid bed dryer, or granulation) to further concentrate the caustic solids in powder or granulate form.

In a further method according to the disclosure, a composition is formed by mixing the reagents and forming a contiguous one phase homogenous solid.

In a still further method, a contiguous solid composition is formed by mixing reagents (e.g. solid caustic and a liquid hydroxyl-containing organic molecule) and subjecting the mixture to an additional energy input. The optional additional energy may be used in the form of heat, radiation, and the like. In a preferred embodiment, the additional energy is microwaving for a short period of time. In exemplary embodiments, microwave energy has frequencies above about 300 megahertz (hereinafter often abbreviated as “MHz”), and are generally regarded as having frequencies in the range of about 300 to about 300,000 MHz. Preferred methods of microwaving are disclosed in U.S. Pat. Nos. 5,858,299 and 6,689,305, each of which are herein incorporated by reference in its entirety. In embodiments employing heat to the reaction, the heat (i.e. microwave) acts to remove water from the solid to speed up/enhance solidification. The formation of water will be shared as a monohydrate with surrounding caustic. The generated precipitates can then be isolated via filtering, separation, and the like for further uses, such as incorporation into various solid compositions.

In an embodiment of the method, the additional energy input occurs for a time period of less than 5 minutes, preferably less than 2 minutes, preferably less than 1 minute, and preferably less than 45 seconds. The compositions of the present disclosure can be formed by combining the components in the weight percentages and ratios disclosed herein. The alkaline compositions can be provided as a solid and a use solution is formed during the application of use.

The solid compositions beneficially can reduce (or eliminate) the use of solid caustic inputs (i.e. caustic beads) in a solid composition. In an embodiment, at least about a 10%, 15%, 20%, 25%, 30%, 40%, 45%, 50%, 55%, 60%, 65%, 70%, 75%, 80%, 85%, 90%, 95%, or 100% reduction of solid caustic is achieved. As described in certain embodiments a 100% reduction (i.e. elimination and free of) of caustic beads is achieved according to the formation of the caustic solid by reacting liquid caustic with the reagents.

Compositions can be produced using a batch or continuous mixing system. In an exemplary embodiment, a single- or twin-screw extruder is used to combine and mix one or more agents at high shear to form a homogeneous mixture. In some embodiments, the processing temperature is at or below the melting temperature of the components. In some embodiments, the processing temperature is at ambient temperature (20-25° C.). In some embodiments, the processing conditions does not include the application of external heat or energy. The processed mixture may be dispensed from the mixer by forming, casting or other suitable means, whereupon the composition hardens to a solid form. The structure of the matrix may be characterized according to its hardness, melting point, material distribution, crystal structure, and other like properties according to known methods in the art. Generally, a solid composition processed according to the methods is substantially homogeneous with regard to the distribution of ingredients throughout its mass and is dimensionally stable.

Specifically, in a forming process, the liquid and/or solid components are introduced into the mixing system and are continuously mixed until the components form a contiguous block. In an exemplary embodiment, the components are mixed in the mixing system for at least approximately 5 seconds, 15 seconds, 30 seconds, 60 seconds, 5 minutes, 10 minutes, 30 minutes, 60 minutes. The mixture is then discharged from the mixing system. In an embodiment, the mixture can be discharged into, or through, a die or other shaping means. The product is then packaged. In an exemplary embodiment, the formed composition begins to harden to a solid form in between approximately 1 minute and approximately 3 hours. Particularly, the formed composition begins to harden to a solid form in between approximately 1 minute and approximately 2 hours. More particularly, the formed composition begins to harden to a solid form in between approximately 1 minute and approximately 20 minutes.

Pressing can employ low pressures compared to conventional pressures used to form tablets or other conventional solid compositions. For example, in an embodiment, the present method employs a pressure on the solid of only less than or equal to about 5000 psi. In certain embodiments, the present method employs pressures of less than or equal to about 3500 psi, less than or equal to about 2500 psi, less than or equal to about 2000 psi, or less than or equal to about 1000 psi. In certain embodiments, the present method can employ pressures of about 1 to about 1000 psi, about 2 to about 900 psi, about 5 psi to about 800 psi, or about 10 psi to about 700 psi.

Specifically, in a casting process, the liquid and solid components are introduced into the final mixing system and are continuously mixed until the components form a substantially homogeneous liquid mixture in which the components are distributed throughout its mass. In an exemplary embodiment, the components are mixed in the mixing system for at least approximately 60 seconds. Once the mixing is complete, the product is transferred to a packaging container where solidification takes place. In an exemplary embodiment, the cast composition begins to harden to a solid form in between approximately 1 minute and approximately 3 hours. Particularly, the cast composition begins to harden to a solid form in between approximately 1 minute and approximately 2 hours. More particularly, the cast composition begins to harden to a solid form in between approximately 1 minute and approximately 20 minutes.

By the term “solid form”, it is meant that the hardened composition will not flow and will substantially retain its shape under moderate stress or pressure or mere gravity. The degree of hardness of the solid cast composition may range from that of a fused solid product which is relatively dense and hard, for example, like concrete, to a consistency characterized as being a hardened paste. In addition, the term “solid” refers to the state of the composition under the expected conditions of storage and use of the solid composition. In general, it is expected that the composition will remain in solid form when exposed to temperatures of up to approximately 100° F. and particularly greater than approximately 120° F.

The resulting solid composition may take forms including, but not limited to: a pressed solid; a cast solid product; an extruded, molded or formed solid pellet, block, tablet, powder, granule, flake; or the formed solid can thereafter be ground or formed into a powder, granule, or flake. In an exemplary embodiment, extruded pellet materials formed have a weight of between approximately 1 gram and 50 grams, or 50 grams and approximately 250 grams, extruded solids generally have a weight of approximately 100 grams or greater, and solid blocks generally have a mass of between approximately 1 and approximately 10 kilograms. The solid compositions provide for a stabilized source of functional materials. In some embodiments, the solid composition may be dissolved, for example, in an aqueous or other medium, to create a concentrated and/or use solution. The solution may be directed to a storage reservoir for later use and/or dilution, or may be applied directly to a point of use. Alternatively, the solid alkaline composition is provided in the form of a unit dose, typically provided as a cast solid, an extruded pellet, or a tablet having a size of between approximately 1 gram and approximately 100 grams. In another alternative, multiple-use solids can be provided, such as a block or a plurality of pellets, and can be repeatedly used to generate aqueous compositions for multiple cycles.

### Reagents for the Solid Compositions

### Caustic Source

The solid compositions contain at least one caustic source. As referred to herein, caustic is synonymous to hydroxide. In an embodiment of the disclosure, any suitable source of caustic may be used. In an embodiment, an alkali metal caustic source may be used. For example, caustic sources may be in the form of sodium hydroxide, potassium hydroxide, lithium hydroxide, derivatives thereof, or and combinations thereof. An example of a derivative of a caustic source is a preformed alkoxide.

In the methods of making the solid composition the caustic source is a solution or a liquid alkali metal hydroxide. In further embodiments additional caustic source can be included in the form of a solid, such as caustic beads, pellets, flakes, powder, granules, and the like may be combined with the liquid alkali metal hydroxide.

In an embodiment a higher active caustic liquid is preferred for the control of equilibrium reaction and kinetics for the generation of solid compositions. In an embodiment, the molar ratio of caustic to reagent (e.g. propylene glycol or other organic compound containing hydroxyl groups) is about 1:1 to about 10:1 molar ratio, about 1:1 to about 8:1 molar ratio, about 1:1 to about 6:1 molar ratio, and preferably about 1:1. In some embodiments, the reaction of glycol reagents is faster to produce the solid compositions.

In an embodiment, a concentrated caustic can be used in the methods of making the solid. In an embodiment, 70% NaOH is preferred over a 50% NaOH to provide the 1:1 (or greater) molar ratio of caustic to reagent. In preferred embodiments, a concentrated alkali metal hydroxide comprises greater than 50% (actives basis) liquid alkali metal hydroxide. In some embodiments, the concentrated alkali metal hydroxide is from about 69% to about 74% (actives basis) liquid alkali metal hydroxide, preferably from about 70% to about 73% (actives basis) liquid alkali metal hydroxide. The concentrated alkali metal hydroxide is maintained a sufficiently high temperatures to prevent premature solidification. In an embodiment the concentrated alkali metal hydroxide is maintained, handled or otherwise processed at a temperature of at least about 66° C., or from about 66° C. to about 85° C.

When a caustic solution is used in the methods of making the solid composition, the caustic is present in an amount of about 0.01 wt.-% to about 99.9 wt.-%. In other embodiments, the caustic solution includes from about 0.1 wt.-% to about 80 wt.-% of the total caustic to make the solid composition. In still other embodiments, the caustic solution includes from about 1 wt.-% to about 50 wt.-% of the total caustic to make the solid composition.

As described herein a liquid and a solid caustic can be combined to make the solid composition. In some embodiments where a solid caustic is employed the alkali metal hydroxide of the composition comprises less than about 40 wt-% solid caustic bead. In further embodiments where a solid caustic is employed, the composition has at least about 20% less solid caustic bead compared to a solid composition that does not contain the alkali metal hydroxide and reagent (e.g. propylene glycol or other organic compound containing hydroxyl groups).

### Organic Molecules with Hydroxyl Groups

In some embodiments, the solid compositions include an organic molecule having at least one hydroxyl group to react with the caustic source to form the solid composition. Any suitable organic molecule having at least one hydroxyl group may be used.

The organic molecule can include solvents and/or surfactants having at least one hydroxyl group to react with the caustic source. In preferred embodiments the organic molecule is a polyol.

In an embodiment, the solvent is an amino alcohol; C1-C22 alcohol; C1-C10 alcohol; a glycol or derivatives thereof; a glycerol or derivatives thereof; alkylene carbonates; diols and derivatives thereof; polyols and derivatives thereof; butyl cellosolve; butyl carbitol; hexylene cellosolve; hexylene carbitol; and the like. In a preferred embodiment, the solvent contains a terminal hydroxyl group.

Exemplary C1-C22 alcohols include for example methanol, ethanol, propanol, isopropanol, decanol, benzyl alcohol and derivatives thereof, and the like.

In embodiments, a polyol is a diol, triol, and/or polyol containing more than 3 hydroxyl groups. Diols include for example, ethylene glycol, propylene glycol, hexylene glycol, tetramethylene glycol (1,4-Butanediol), etc. An exemplary triol is glycerin. An exemplary polyol is D-Sorbitol (6 hydroxyl groups).

Exemplary polyols include glycols and derivatives thereof including, ethylene glycol, propylene glycol, hexylene glycol, ethylene glycol phenyl ether, propylene glycol n-propyl ether, propylene glycol phenyl ether, dipropylene glycol n-propyl ether, and the like. Further exemplary glycerols and derivatives include, glycerol ethyl hexyl glyceryl ether, glycerin, glycerol formal, glycerol ketal, and the like. Exemplary polyols, diols and derivatives include, 3-butanediol, 1,4-butanediol, 2-ethy-1,3,-hexanediol, 1-3-propane diol, 2-methyl-2-propyl-1,3-propanediol, and the like.

A preferred polyol is glycerin. In an embodiment crude glycerin (˜85% active) is the preferred polyol. As the terms glycerin and glycerol may be used interchangeably. Further exemplary glycerols and derivatives include, glycerol ethyl hexyl glyceryl ether, glycerin, glycerol formal, glycerol ketal, and the like.

Exemplary amino alcohols include alkanolamines which have the following general structure of an amine and an alcohol group: NH₍₃₋ₙ₎(CH₂CH₂OH)ₙ, where n=1, 2, or 3. Preferred alkaline solvents are monoethanolamine (MEA), diethanolamine (DEA), and triethanolamine (TEA).

Exemplary oxygenated solvents include those having the following formulas:

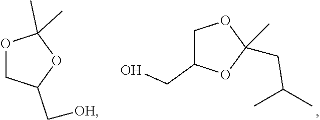

and the like.

Exemplary surfactants having at least one hydroxyl group include, but are not limited to, ethylhexyl glycol ether, ethoxylated gemini diols (available as Envirogem 360 from Air Products), and ethoxylated alcohol surfactants (available as Tomadol 91-2.5 and Tomadol 1-3 from Evonik). An advantage of using surfactant over traditional hydroxyl group containing solvents is that surfactants are also surface active. Therefore, the use of surfactants offers dual purposes of solidification and surface wetting/cleaning in various detergent formulations.

According to various embodiments the organic molecule having at least one hydroxyl group is included as a reagent to make the solid compositions in an amount of about 1 wt-% to about 50 wt-%, about 1 wt-% to about 40 wt-%, about 1 wt-% to about 20 wt-%, about 1 wt-% to about 15 wt-%, or about 1 wt-% to about 10 wt-%.

### Alkylene Carbonates

In some embodiments, the solid compositions include an alkylene carbonate to react with the caustic source to form the solid composition. Any suitable alkylene carbonate may be used.

Exemplary alkylene carbonates include for example, glycerin carbonate, ethylene carbonate, propylene carbonate, butylene carbonate, carbonate esters, and the like. A carbonate ester has a carbonyl group flanked by two alkoxy groups. In an embodiment, a cyclic organic ester is provided in the carbonate structure, such as shown for ethylene carbonate, propylene carbonate, and butylene carbonate, as follows respectively, is employed, however, any chain length of the alkyl group can be employed:

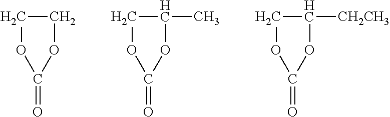

Alkylene carbonates are commercially-available (Huntsman, available under Jeffsol® tradename) and often referred to as glycol carbonates or cyclic carbonates. They are often used as reactive intermediates to replace ethylene and propylene oxides and ethylene and propylene glycols.

In embodiments the molar ratio of the initial alkali metal hydroxide to alkylene carbonate combined to make the solid composition is from about 0.5:1 to about 10:1, or from about 0:71:1 to about 9.8:1.

According to various embodiments the alkylene carbonate is included as a reagent to make the solid compositions in an amount of about 1 wt-% to about 50 wt-%, about 1 wt-% to about 40 wt-%, about 1 wt-% to about 20 wt-%, about 1 wt-% to about 15 wt-%, or about 1 wt-% to about 10 wt-%.

### Additional Functional Ingredients

The solid compositions may further include additional functional materials or additives that provide a beneficial property, e.g., for a particular use. Examples of conventional additives include one or more of each of salt or additional salt, chelant, alkalinity source, surfactant, detersive polymer, cleaning agent, rinse aid composition, softener, pH modifier, source of acidity, anti-corrosion agent, secondary hardening agent, solubility modifier, detergent builder, detergent filler, defoamer, anti-redeposition agent, antimicrobial, rinse aids, a threshold agent or system, aesthetic enhancing agent (i.e., dye, odorant, perfume), optical brightener, lubricant composition, bleaching agent, enzyme, effervescent agent, activator for an active oxygen compound, other such additives or functional ingredients, and the like, and mixtures thereof. Adjuvants and other additive ingredients will vary according to the type of composition being manufactured, and the intended end use of the solid composition.

In some embodiments, the compositions further include a functional anhydrous material to absorb excess water from the mixture of hydrated solids in the composition. Examples of such a functional anhydrous material, include, but are not limited to, sodium carbonate (ash), sodium sulfate, solid caustic, and the like. Without being limited to a particular mechanism, the addition of a functional anhydrous material forms hydrate compounds upon contact with excess water, thus removing the excess water from the mixture.

### Methods of Use

The present disclosure includes methods of using the solid compositions for various cleaning applications. These cleaning compositions can operate on an article, surface, in a body or stream of water or a gas, or the like, by contacting the article, surface, body, or stream with a composition of the disclosure. Contacting can include any of numerous methods for applying a cleaning composition of the disclosure, such as spraying the compositions, immersing the article in compositions, foam or gel treating the article with the compounds or composition, or a combination thereof.

It should be understood that the concentration of the ingredients in the solid compositions will vary depending on whether the cleaning composition is provided as a concentrate or as a use solution.

A use solution may be prepared from the concentrate by diluting the concentrate with water at a dilution ratio that provides a use solution having desired detersive properties. The water that is used to dilute the concentrate to form the use composition can be referred to as water of dilution or a diluent, and can vary from one location to another. The typical dilution factor is between approximately 1 and approximately 10,000 but will depend on factors including water hardness, the amount of soil to be removed and the like. In an embodiment, the concentrate is diluted at a ratio of between about 1:10 and about 1:10,000 concentrate to water. Particularly, the concentrate is diluted at a ratio of between about 1:100 and about 1:5,000 concentrate to water. More particularly, the concentrate is diluted at a ratio of between about 1:250 and about 1:2,000 concentrate to water.

In some embodiments, the cleaning compositions are used in methods for cleaning soiled surfaces via use of a degreaser composition. In one embodiment, the present disclosure is a method for cleaning polymerized fat soils. The cleaning methods generally use non-corrosive degreaser compositions incorporating the compositions as described herein. In certain embodiments, an environmental cleaning method is provided. In other embodiments, a clean in place (CIP) method is provided. According to further embodiments of the invention, non-corrosive degreaser compositions can be used in any other methods seeking to remove polymerized soils without requiring the use of corrosive formulations, such as removing polymerized or cross-linked films from floors and other finishes. Beneficially, degreaser compositions do not require use of personal protective equipment as a result of the pH below about 11.5. In addition, the degreaser compositions achieve degreasing action within approximately 5 seconds to a few minutes of contact to a soiled surface. According to a preferred embodiment of the invention, application of degreaser compositions result in soil removal within about 10 seconds without requiring substantial mechanical action or excessive temperatures. The methods of the present disclosure result in cleaning efficacy at least the same as that obtained with the use of corrosive, highly alkaline compositions of the prior art.

Exemplary industries in which the present methods can be used include, but are not limited to: food service industry; food and beverage industry; consumer degreasing applications; oil processing industry; industrial agriculture and ethanol processing; and the pharmaceutical manufacturing industry. Suitable uses for the compositions and methods of the invention may include, for example, oven cleaner, including microwave ovens, general degreaser, fryer degreaser, smokehouse cleaner, floor cleaner, exhaust hood cleaner, drain cleaner, floor finish remover, floor cleaner, fryer cleaner, pot and pan cleaner, carpet spotter, pharmaceutical and cosmetics cleaner, instrument cleaner, tar remover, and the like.

The present methods can also be used to remove soils other than polymerized soils, such as those removed with degreaser compositions. Such other soils include, but are not limited to, starch, cellulosic fiber, protein, simple carbohydrates and combinations of any of these soil types with mineral complexes. Examples of specific food soils that are effectively removed using the present methods include, but are not limited to, soils generated in the manufacture and processing meat, poultry, vegetables and fruit, bakery goods, soft drinks, brewing and fermentation residues, soils generated in sugar beet and cane processing and processed foods containing these ingredients and associated ingredients such as juices, sauces and condiments (e.g., fruit juices, ketchup, tomato sauce, barbeque sauce). These soils can develop on environmental surfaces such as walls and floors, freezers and cooling systems, heat exchange equipment surfaces, conveyor surfaces and on other surfaces during the manufacturing and packaging process.

In further embodiments, the methods of employing cleaning compositions are particularly suited for use in closed systems, e.g. dish or ware washing systems for cleaning, sanitizing and/or disinfecting articles and surfaces.

The method includes contacting an article or surface with a cleaning composition or a cleaning use composition to wash the surface. The method can contact the liquid to any of a variety of surfaces or objects including surfaces or articles including those made of glass, ceramic, plastic, porcelain, aluminum, or the like.

The phrase “washing a surface with a wash solution (or a use solution or a cleaning composition)” refers to the circulation of a cleaning composition solution to remove substantially all soil from the treated surfaces (e.g. ware) and to keep that soil suspended or dissolved. In an embodiment, this step may be conducted where the temperature of the rinse water is up to about 140° F., preferably in the range of 100° F. to 140° F., preferably in the range of 110° F. to 140° F., and most preferably in the range of 120° F. to 140° F. As referred to herein, “low temperature” refers to those rinse water temperatures below about 140° F. For example, conventional rinse temperature for ware washing occurs above 140° F., such as from about 140° F. to about 190° F., particularly between about 145° F. to about 180° F. In an aspect, the methods of the invention employing a low temperature further employ a sanitizer.

Contacting can include any of numerous methods for applying a cleaning composition, such as spraying the composition, immersing the object in the composition, or a combination thereof. A concentrate or use concentration of a composition can be applied to or brought into contact with an article by any conventional method or apparatus for applying a cleaning composition to an object. For example, the object can be wiped with, sprayed with, and/or immersed in the composition, or a use solution made from the composition. The composition can be sprayed, or wiped onto a surface; the composition can be caused to flow over the surface, or the surface can be dipped into the composition. Contacting can be manual or by machine.

Before contacting an article or surface, a concentrate cleaning composition may be first diluted with water at the location of use to provide the use solution. When the composition is used in an automatic warewashing or dishwashing machine, it is expected that that the location of use will be inside the automatic warewashing machine. Depending on the machine, the composition may be provided in a unit dose form or in a multi-use form. In larger warewashing machines, a large quantity of composition may be provided in a compartment that allows for the release of a single dose amount of the composition for each wash cycle. Such a compartment may be provided as part of the warewashing machine or as a separate structure connected to the warewashing machine.

The cleaning composition may also be dispensed from a spray-type dispenser, such as that disclosed in U.S. Pat. Nos. 4,826,661, 4,690,305, 4,687,121, 4,426,362 and in U.S. Pat. Nos. Reissue 32,763 and 32,818, the disclosures of which are incorporated by reference herein. Briefly, a spray-type dispenser functions by impinging a water spray upon an exposed surface of the composition, and then immediately directing the use solution out of the dispenser to a storage reservoir or directly to a point of use. If necessary, in some embodiments, when used, the product may be removed from the packaging and inserted into the dispenser.

The methods may further employ one or more rinse steps for the treated articles or surfaces. In an aspect, the commercial use of the phosphorus-free detergent compositions at low temperatures preferably include a rinse step employing a rinse aid, including for example, the disclosure of using rinse aids set forth in U.S. patent application Ser. No. 13/480,031, which is herein incorporated by reference in its entirety.

The compositions of the present disclosure can be used to remove stains from any conventional textile, including but not limited to, cotton, poly-cotton blends, wool, and polyesters. The compositions can be used on any item or article made from or including textile materials, woven fabrics, non-woven fabrics, and knitted fabrics. The textile materials can include natural or synthetic fibers such as silk fibers, linen fibers, cotton fibers, polyester fibers, polyamide fibers such as nylon, acrylic fibers, acetate fibers, and blends thereof including cotton and polyester blends. The fibers can be treated or untreated. Such textiles are commonly used as table linens, kitchen rages, chef coats, massage towels, etc. and other applications wherein greasy and oily soils are expected.

The compositions of the present disclosure are also textile tolerant, i.e., they will not substantially degrade the textile to which they are applied. The compounds of the present disclosure can be used to remove a variety of stains from a variety of sources including, but not limited to, lipstick, pigment/sebum, pigment/lanolin, soot, olive or other vegetable oils, mineral oil, motor oil, other oils, blood, make-up, red wine, tea, ketchup, organic grease and fat soils, including those from meat, protein and/or carbohydrate sources, any additional soils and combinations thereof.

In conventional, industrial and/or commercial laundry washing applications of use, the methods of removing soils from a textile may be employed either inside or outside a washing machine, when employing a method of removing soils in a laundry application. In some aspects, when the aqueous composition is employed outside the washing machine it is used in a concentrated formulation. In other aspects, when the aqueous composition is employed inside the washing machine it is used in a diluted (or a highly diluted) formulation, such as within the wash liquor of a washing machine in order to remove soils from textiles.

In a conventional, industrial laundry washing facility, textile materials can be subjected to several treatment steps in an industrial sized laundry washing machine to provide cleaning Exemplary treatment steps include a presoak or a prewash step, a wash step (e.g. soap and suds step), a rinse step for the removal of soil containing wash liquor, a bleach step (separate or in combination with the wash step), several optional rinse steps to remove the bleaching composition, an optional sour step to adjust the pH, softening step, and an extract step that often involves spinning the textiles to remove water. The compositions of the invention can be employed in such exemplary conventional prewash or presoak steps, washing steps, and/or alternatively be used in washing treatment steps that vary from such conventional processes. In addition, the compositions of the invention may be employed with a variety of laundry washing machines, including industrial, commercial and/or consumer machines (e.g. residential and/or home laundry washing machine).

The method for treating laundry can be provided as part of an overall method for cleaning laundry. That is, as part of a laundry cleaning operation, the compositions of the present disclosure can be used alone to treat the articles, e.g., textiles, or can be used in conjunction with conventional detergents suitable for the articles to be treated. A laundry cleaning process can include the removal of soil, the removal of staining or the appearance of staining, and/or the reduction of a population of microbes. The compositions can be used with conventional detergents in a variety of ways, for example, the compositions of the invention can be formulated with a conventional detergent. Such formulation can include, for example, detergents for a pre-wash or pre-soak step and/or a soap/suds/bleach step. When the compositions of the invention are used in combination with conventional detergents, the compositions are employed to provide a detergency booster, such that the emulsifying efficacy of the compositions are combined with cleaning and/or bleaching efficacy of conventional detergents.

In other embodiments, the compositions can be used to treat the article as a separate additive from a conventional detergent. The compositions can be provided in the form of a concentrate that is diluted with water to provide a use solution. Alternatively, the compositions can be provided in the form of a use solution (already diluted with water). When used as a separate additive, the compositions of the present disclosure can contact the article to be treated at any time. For example, the compounds and compositions of the invention can contact the article before, after, or substantially simultaneously as the articles are contacted with the selected detergent.

In some embodiments, the cleaning compositions include killing one or more of the pathogenic bacteria associated with health care surfaces and environments including, but not limited to, Salmonella typhimurium, Staphylococcus aureus, methicillin resistant Staphylococcus aureus, Salmonella choleraesurus, Pseudomonas aeruginosa, Escherichia coli, mycobacteria, yeast, and mold. The cleaning compositions have activity against a wide variety of microorganisms such as Gram positive (for example, Listeria monocytogenes or Staphylococcus aureus) and Gram negative (for example, Escherichia coli or Pseudomonas aeruginosa) bacteria, yeast, molds, bacterial spores, viruses, etc. The compounds and compositions of the present disclosure, as described above, have activity against a wide variety of human pathogens. The cleaning compositions can kill a wide variety of microorganisms on a food processing surface, on the surface of a food product, in water used for washing or processing of food product, on a health care surface, or in a health care environment.

The present methods can be used to achieve any suitable reduction of the microbial population in and/or on the target or the treated target composition. In some embodiments, the present methods can be used to reduce the microbial population in and/or on the target or the treated target composition by at least one log10. In other embodiments, the present methods can be used to reduce the microbial population in and/or on the target or the treated target composition by at least two log10. In still other embodiments, the present methods can be used to reduce the microbial population in and/or on the target or the treated target composition by at least three log10. In still other embodiments, the present methods can be used to reduce the microbial population in and/or on the target or the treated target composition by at least five log10. Without limiting the scope of disclosure, the numeric ranges are inclusive of the numbers defining the range and include each integer within the defined range.

The cleaning compositions can be used for a variety of domestic or industrial applications, e.g., to reduce microbial or viral populations on a surface or object or in a body or stream of water. The cleaning compositions can be applied in a variety of areas including kitchens, bathrooms, factories, hospitals, dental offices and food plants, and can be applied to a variety of hard or soft surfaces having smooth, irregular or porous topography. Suitable hard surfaces include, for example, architectural surfaces (e.g., floors, walls, windows, sinks, tables, counters and signs); eating utensils; hard-surface medical or surgical instruments and devices; and hard-surface packaging. Such hard surfaces can be made from a variety of materials including, for example, ceramic, metal, glass, wood or hard plastic. Suitable soft surfaces include, for example paper; filter media; hospital and surgical linens and garments; soft-surface medical or surgical instruments and devices; and soft-surface packaging. Such soft surfaces can be made from a variety of materials including, for example, paper, fiber, woven or nonwoven fabric, soft plastics and elastomers. The cleaning compositions can also be applied to soft surfaces such as food and skin (e.g., a hand). The present compounds can be employed as a foaming or non-foaming environmental sanitizer or disinfectant.

The cleaning compositions can be included in products such as degreasers, sterilants, sanitizers, disinfectants, preservatives, deodorizers, antiseptics, fungicides, germicides, sporicides, virucides, detergents, bleaches, hard surface cleaners, hand soaps, waterless hand sanitizers, lubricants, rinse aids, 2-in-1 and/or 3-in-1 products, such as insecticide/cleaner/sanitizer, 3-sink applications, and pre-or post-surgical scrubs.

The cleaning compositions can be applied to microbes or to soiled or cleaned surfaces using a variety of methods. These methods can operate on an object, surface, in a body or stream of water or a gas, or the like, by contacting the object, surface, body, or stream with a compound of the disclosure. Contacting can include any of numerous methods for applying a compound, such as spraying the compound, immersing the object in the compound, foam or gel treating the object with the compound, or a combination thereof.

A concentrate or use concentration of a cleaning composition can be applied to or brought into contact with an object by any conventional method or apparatus for applying an antimicrobial or cleaning compound to an object. For example, the object can be wiped with, sprayed with, foamed on, and/or immersed in the compound, or a use solution made from the composition. The cleaning composition can be sprayed, foamed, or wiped onto a surface; the composition can be caused to flow over the surface, or the surface can be dipped into the cleaning composition. Contacting can be manual or by machine. Food processing surfaces, food products, food processing or transport waters, and the like can be treated with liquid, foam, gel, aerosol, gas, wax, solid, or powdered stabilized compounds according to the disclosure, or solutions containing these compounds.

Cleaning compositions of the disclosure can be formulated and sold for use as is, or as solvent or solid concentrates. If desired, such concentrates can be used full-strength as sanitizing rinse compositions. However, the concentrates typically will be diluted with a fluid (e.g., water) that subsequently forms the dilute phase or a use solution. Preferably, the concentrate forms a single phase before such dilution and remains so while stored in the container in which it will be sold. When combined with water or other desired diluting fluid at an appropriate dilution level and subjected to mild agitation (e.g., by stirring or pumping the composition), some compositions of the disclosure will form a pseudo-stable dispersion, and other compositions of the disclosure will form a clear or quasi-stable solution or dispersion. If a pseudo-stable composition is formed, then the composition preferably remains in the pseudo-stable state for a sufficiently long period so that the composition can be applied to a surface before the onset of phase separation. The pseudo-stable state need only last for a few seconds when suitably rapid application techniques such as spraying are employed, or when agitation during application is employed. The pseudo-stable state desirably lasts for at least one minute or more after mixing and while the composition is stored in a suitable vessel, and preferably lasts for five minutes or more after mixing. Often normal refilling or replenishment of the applicator (e.g., by dipping the applicator in the composition) will provide sufficient agitation to preserve the pseudo-stable state of the composition during application.

The various applications of use described herein provide the cleaning compositions to a surface and/or water source. Beneficially, the cleaning compositions of the disclosure are fast-acting. However, the present methods require a certain minimal contact time of the compositions with the surface or product in need of treatment for occurrence of sufficient antimicrobial effect. The contact time can vary with concentration of the use compositions, method of applying the use compositions, temperature of the use compositions, pH of the use compositions, amount of the surface or product to be treated, amount of soil or substrates on/in the surface or product to be treated, or the like. The contact or exposure time can be about 15 seconds, at least about 15 seconds, about 30 seconds or greater than 30 seconds. In some embodiments, the exposure time is about 1 to 5 minutes. In other embodiments, the exposure time is a few minutes to hours. In other embodiments, the exposure time is a few hours to days. The contact time will further vary based upon the use concentration of actives of compositions according to the disclosure.

All publications and patent applications in this specification are indicative of the level of ordinary skill in the art to which this disclosure pertains. All publications and patent applications are herein incorporated by reference to the same extent as if each individual publication or patent application was specifically and individually indicated as incorporated by reference.

### EMBODIMENTS

The present disclosure is further defined by the following numbered embodiments:

[Embodiment 1] A solid composition comprising: an alkali metal hydroxide; an organic molecule having at least one hydroxyl group; and water; wherein the weight ratio of the alkali metal hydroxide to water in the solid composition is from about 27:73 to about 75:25, and wherein the composition is a contiguous solid, powder or granule.

The solid composition of embodiment 1, wherein the alkali metal hydroxide is sodium hydroxide, potassium hydroxide, lithium hydroxide, derivatives thereof, or combinations thereof.

The solid composition of any one of embodiments 1-2, wherein the organic molecule having at least one hydroxyl group is defined as a polyol.

The solid composition of embodiment 3, wherein the polyol comprises glycol, glycerin or sorbitol.

The solid composition of any one of embodiments 1-4, further comprising an anhydrous material to absorb excess water in the composition.

The solid composition of any one of embodiments 1-5, wherein the weight ratio of the alkali metal hydroxide to water in the solid composition is from about 50:50 to about 75:25, or from about 60:40 to about 70:30.

The solid composition of any one of embodiments 1-6, wherein the molar ratio of caustic to water is about 1:2.2 to about 1:1.

The solid composition of any one of embodiments 1-7, further comprising an additional functional ingredient.

The solid composition of embodiment 8, wherein the additional functional ingredient comprises one or more of a salt, chelating/sequestering agent, alkalinity source, surfactant, detersive polymer, cleaning agent, rinse aid composition, softener, pH modifier, source of acidity, anti-corrosion agent, secondary hardening agent, solubility modifier, detergent builder, detergent filler, defoamer, anti redeposition agent, antimicrobial, rinse aid composition, a threshold agent or system, aesthetic enhancing agent, optical brightener, lubricant, bleaching agent, enzyme, effervescent agent, or activator for an active oxygen compound.

The composition of any one of embodiments 1-9, wherein the alkali metal hydroxide of the composition comprises less than about 40 wt-% solid caustic bead.

The composition of any one of embodiments 1-10, wherein the composition has at least about 20% less solid caustic bead compared to a solid composition that does not contain the alkali metal hydroxide and organic molecule having at least one hydroxyl group forming the solid composition.

[Embodiment 12] A method of forming the solid composition according to any one of embodiments 1-11, comprising: mixing the organic molecule containing at least one hydroxyl group with a liquid alkali metal hydroxide; and either (a) forming in situ a contiguous solid composition or (b) isolating the solid as a precipitate material, wherein the molar ratio of the alkali metal hydroxide to polyol is between about 1:1 and about 10:1.

The method of embodiment 12, wherein the solid composition does not require the use of an additional caustic source or anhydrous source to absorb excess water.

The method of any one of embodiments 12-13, wherein the isolated precipitate material is further dehydrated or combined with a functional anhydrous material to remove excess water, such as for use in a solid composition or as a pre-mix.

The method of any one of embodiments 12-14, wherein the isolated precipitate material is spray dried to provide a powder or granule.

The method of any one of embodiments 12-15, wherein the method takes place at ambient temperature and/or does not require a chiller step.

The method of any one of embodiments 12-16, wherein the solid composition is formed between about 1 minute and about 3 hours, or between about 1 minute and about 20 minutes.

The method of any one of embodiments 12-17, further comprising combining the at least one additional functional ingredient to form the solid composition.

The method of any one of embodiments 12-18, further comprising transferring the reagents into a container or housing before the forming in situ of the contiguous solid composition.

The method of any one of embodiments 12-19, wherein the method does not include a chilling step to lower the temperature below a solidification temperature.

[Embodiment 21] A solid composition comprising: an alkali metal hydroxide and/or an alkali metal carbonate; an alkylene carbonate; and water; wherein the molar ratio of the initial alkali metal hydroxide to alkylene carbonate combined to make the solid composition is from about 0.5:1 to about 10:1, and wherein the composition is a contiguous solid, powder or granule.

The solid composition of embodiment 21, wherein the alkali metal hydroxide is sodium hydroxide, potassium hydroxide, lithium hydroxide, derivatives thereof, or combinations thereof.

The solid composition of any one of embodiments 21-22, wherein the alkylene carbonate is glycerin carbonate, ethylene carbonate, propylene carbonate, or butylene carbonate.

The solid composition of any one of embodiments 21-23, further comprising an anhydrous material to absorb excess water in the composition.

The solid composition of any one of embodiments 21-24, further comprising an additional functional ingredient.

The solid composition of embodiment 25, wherein the additional functional ingredient comprises one or more of a salt, chelating/sequestering agent, alkalinity source, surfactant, detersive polymer, cleaning agent, rinse aid composition, softener, pH modifier, source of acidity, anti-corrosion agent, secondary hardening agent, solubility modifier, detergent builder, detergent filler, defoamer, anti redeposition agent, antimicrobial, rinse aid composition, a threshold agent or system, aesthetic enhancing agent, optical brightener, lubricant, bleaching agent, enzyme, effervescent agent, or activator for an active oxygen compound.

The composition of any one of embodiments 21-26, wherein the alkali metal hydroxide of the composition is free of solid caustic bead.

The composition of any one of embodiments 21-27, wherein the composition has at least about 50% less solid caustic bead compared to a solid composition that does not contain the alkali metal hydroxide and alkylene carbonate forming the solid composition.

[Embodiment 29] A method of forming the solid composition according to any one of embodiments 21-28, comprising: mixing the alkylene carbonate with a liquid alkali metal hydroxide; and either (a) forming in situ a contiguous solid composition or (b) isolating the solid as a precipitate material, wherein the molar ratio of the initial alkali metal hydroxide to alkylene carbonate is from about 0.5:1 to 10:1.

The method of embodiment 29, wherein the solid composition does not require the use of an additional caustic source or anhydrous source to absorb excess water.

The method of any one of embodiments 29-30, wherein the isolated precipitate material is further dehydrated or combined with a functional anhydrous material to remove excess water, such as for use in a solid composition or as a pre-mix.

The method of any one of embodiments 29-31, wherein the isolated precipitate material is spray dried to provide a powder or granule.

The method of any one of embodiments 29-32, wherein the method takes place at ambient temperature and/or does not require a chiller step.

The method of any one of embodiments 29-33, wherein the solid composition is formed between about 1 minute and about 3 hours, or between about 1 minute and about 20 minutes.

The method of any one of embodiments 29-34, further comprising combining the at least one additional functional ingredient to form the solid composition.

The method of any one of embodiments 29-35, further comprising transferring the reagents into a container or housing before the forming in situ of the contiguous solid composition.

The method of any one of embodiments 29-36, wherein the method does not include a chilling step to lower the temperature below a solidification temperature.

A method of using the composition of any one of embodiments 1-11 or 21-28 for cleaning, disinfecting, and/or sanitizing comprising: contacting an article or surface in need of cleaning, disinfecting, and/or sanitizing with the solid composition of any one of embodiments 1-11 or 21-28; and cleaning, disinfecting, and/or sanitizing the article or surface.

The method of embodiment 38, further comprising a step of diluting the solid composition to form a use solution to contact the article or surface.

The method of embodiment 39, wherein the use solution is formed on-site and/or during in-situ generation of the solid composition.

### EXAMPLES

Embodiments of the present disclosure are further defined in the following non-limiting Examples. These Examples, while indicating certain embodiments of the disclosure, are given by way of illustration only. From the above discussion and these Examples, one skilled in the art can ascertain the essential characteristics of this disclosure, and without departing from the spirit and scope thereof, can make various changes and modifications of the embodiments of the disclosure to adapt it to various usages and conditions. Thus, various modifications of the embodiments of the disclosure, in addition to those shown and described herein, will be apparent to those skilled in the art from the foregoing description. Such modifications are also intended to fall within the scope of the appended claims.

The following Examples provide exemplary embodiments of the solid compositions formed according to the methods described herein.

The following materials were employed:

DBU: 1,8-Diazabicyclo[5.4.0]undec-7-ene

THEED: N,N,N′,N′-Tetrakis(2--hydroxyethyl)-ethylene diamine

Lonzabac 12.100: bis (3-aminopropyl) dodecylamine (INCI-name: laurylamine dipropylenediamine)

Sokalan HP 50: polyvinyl pyrrolidone

Nalco DVS3C008: phosphinic acid, sodium salt

Nalco Polymer: anionic terpolymer of acrylic acid, maleic acid, and 2-acrylamido-2-methyl-1-propanesulfonic acid (ATBS)

Acusol 880: hydrophobically modified nonionic polyol (HEUR) thickener and stabilizer

Glycerol formal, formula as follows:

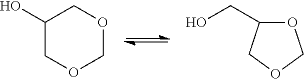 [SMILES: OC1COCOC1 ; OCC1COCO1]

Augeo Clean Multi: oxygenated solvent CASRN: 100-79-8, formula as follows:

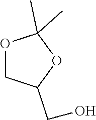

Augeo Clean Plus: solvent CASRN: 5660-53-7, formula as follows:

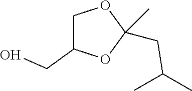

Acusol 448: 3000 MW polyacrylic:polymaleic copolymer

Acusol 445ND: homopolymer of acrylic acid, fully neutralized, spray dried detergent polymer

Pluronic 25-R-2: long chain EO/PO block copolymer

Surfonic LD-097: Polyoxypropylene Polyoxyethylene Block Copolymer (26% EO & 30% PO)

Dissolvine DZ: Diethylenetriaminepentaacetic acid, Nitrilotriacetic acid

Esperase 6.0T: minimum enzyme activity of 6.0 KNPU/g. and is in the class of subtilisin derived from bacillus subtillis (EC 3.4.21.62)

PSO: Phosphinosuccinic Oligomer

Pluronic N3: low foaming nonionic surfactant

Acusol 445N: homopolymer of acrylic acid with molecular weight around 4500

Linear Alcohol (C12-C16) 7EO: polyethylene glycol ether that contains a mixture of synthetic C12-16 fatty alcohols

LAS 90%: Linear alkylbenzene sulfonates

AOS 40%: Alpha olefin sulfonate

Additional Polymer EXP000929 (Batch XC9B1410): 85% Acrylic Acid, 10% Maleic Acid, 5% ATBS, water conditioning polymer

### Example 1

Exemplary alkoxide premixes and full compositions made with alkanolamines are shown in Tables 2A-2D. A description of the visual and tactile observations of the formed solids (or non-solids) are described in each table.

TABLE 2A
Mixed Alkoxides of EG & Various Tertiary Alkanolamines

| | Solid formulations from alkoxides made | | | | | | | |
|---|---|---|---|---|---|---|---|---|
| | with different combinations of additives | | | | | | | |
| | 1 | | 2 | | 3 | | 4 | |
| Description | Wgt., g | Wgt., % | Wgt., g | Wgt., % | Wgt., g | Wgt., % | Wgt., g | Wgt., % |
| Sodium Hydroxide | 56.35 | 48.54 | 56.36 | 75.64 | 100.81 | 50.15 | 75.67 | 34.81 |
| 50% | | | | | | | | |
| Ethylene Glycol | 32.76 | 28.22 | 32.87 | 44.11 | 70.41 | 35.03 | | |
| DBU | 26.98 | 23.24 | | | | | | |
| THEED | | | 41.64 | 55.89 | 29.79 | 14.82 | | |
| Triethanolamine 99% | | | | | | | 141.71 | 65.19 |
| Totals | 116.09 | 100 | 74.51 | 100 | 201.01 | 100 | 217.38 | 100 |
| Molar Amounts | 0.70 | 0.53 | 0.70 | 0.71 | 1.26 | 1.13 | 0.95 | 0.95 |
| (NaOH, Polyol) | | | | | | | | |

| Molar Ratios, | 1.33 | 0.99 | 1.11 | 1.00 |
|---|---|---|---|---|
| NaOH:Polyols | | | | |
| Observations | Semi-solid more of | Continuous | Continuous | Paste-like solids, |
| | an emulsion or | Solid | Solid | somewhat tacky |
| | suspension | | | |

TABLE 2B
Mixed Alkoxides of EG & Various Tertiary et al Alkanolamines

| | Solid formulations from alkoxides made | | | | | | | |
|---|---|---|---|---|---|---|---|---|
| | with different combinations of additives | | | | | | | |
| | 5 | | 6 | | 7 | | 8 | |
| Description | Wgt., g | Wgt., % | Wgt., g | Wgt., % | Wgt., g | Wgt., % | Wgt., g | Wgt., % |
| Sodium Hydroxide | 74.89 | 48.33 | 50.10 | 45.80 | 50.33 | 42.95 | 31.02 | 21.07 |
| 50% | | | | | | | | |
| Ethylene Glycol | 44.38 | 28.64 | 29.25 | 26.74 | | | | |
| Triethanolamine | 35.70 | 23.04 | | | | | | |
| 99% | | | | | | | | |
| Triisopropanolamine | | | 30.05 | 27.47 | | | | |
| 2- | | | | | 66.84 | 57.05 | | |
| (Aminoethoxy)ethanol | | | | | | | | |
| DRM | | | | | | | | |
| Lonzabac 12.100 | | | | | | | 116.21 | 78.93 |
| Totals | 154.97 | 100 | 109.40 | 100 | 117.17 | 100 | 147.23 | 100 |
| Molar Amounts | 0.94 | 0.24 | 0.63 | 0.47 | 0.63 | 0.14 | 0.39 | 0.39 |
| (NaOH, Polyol) | | | | | | | | |

| Molar Ratios, | 3.91 | 0.82 | 0.99 | 1.00 |
|---|---|---|---|---|
| NaOH:Polyols | | | | |
| Observations | Brownish, clumpy, | Brownish, clumpy, | Didn't form a | Didn't form a |
| | slightly moist solids. | semi-dry solids. | continuous solid, | continuous solid, |
| | Became more of a | | instead a two phase | and the homogeneous |
| | lighter brown paste | | system. | mixture was neutral |
| | after mixing using | | | to pH Paper. |
| | a FlackTek Speed | | | |
| | Mixer. | | | |

TABLE 2C

| | Solid formulations from alkoxides made | | | | | |
|---|---|---|---|---|---|---|
| | with different combinations of additives | | | | | |
| | 9 | | 10 | | 11 | |
| Description | Wgt., g | Wgt., % | Wgt., g | Wgt., % | Wgt., g | Wgt., % |
| NaOH-EG Premix | 19.36 | 19.35 | | | | |
| NaOH-EG-THEED Premix | | | 19.21 | 19.19 | 19.33 | 19.33 |
| Sodium Carbonate | 57.85 | 57.82 | 57.93 | 57.87 | 58.06 | 58.06 |
| Commercial Warewash Premix | 9.20 | 9.19 | 9.26 | 9.25 | 9.28 | 9.28 |
| (Remainder - Special); | | | | | | |
| No PSO, 448 or Na₂SO₄ | | | | | | |
| Sokalan HP 50 (Polyvinyl | 5.02 | 5.02 | 5.03 | 5.02 | 5.05 | 5.05 |
| Pyrrolidone) | | | | | | |
| Nalco DVS3C008 (Phosphinic | 1.51 | 1.51 | 1.56 | 1.56 | 1.54 | 1.54 |
| acid, sodium salt) | | | | | | |
| Nalco Polymer | 3.08 | 3.08 | 3.09 | 3.09 | | |
| Acusol 880 (HEUR) | | | | | 3.08 | 3.08 |
| Tetrasodium EDTA Powder | 4.04 | 4.04 | 4.02 | 4.02 | 3.66 | 3.66 |
| Totals | 100 | 100 | 100.10 | 100 | 100.00 | 100 |

| | | | |
|---|---|---|---|
| Molar Ratios, initial | 1.47 | 1.00 | 1.00 |
| NaOH:Polyols | | | |
| Observations | One phase system, | Somewhat flowable, | Somewhat flowable, |
| | but too soft to | moderately suitable | moderately suitable |
| | cast or press. | for pressing | for pressing |
| | | | (slightly tacky). |

Note:
NaOH-EG Premix in 15170-3-5 is an extremely strong base organic compound and was used to boost alkalinity. THEED in Formulas 10 and 11 is a di-cyclic amino polyol.

TABLE 2D

| | Polyol-Metal Alkoxides | | | | | |
|---|---|---|---|---|---|---|
| | 12 | | 13 | | 14 | |
| Description | Wgt., g | Wgt., % | Wgt., g | Wgt., % | Wgt., g | Wgt., % |
| Sodium Hydroxide 50% | 50.82 | 56.76 | 50.18 | 48.13 | 50.26 | 67.00 |
| Glycerin 96% | 38.71 | 43.24 | | | | |
| Monoethanolamine 99% IBC | | | 24.99 | 23.97 | | |
| Benzyl Alcohol | | | 29.08 | 27.89 | | |
| Triethanolamine 99% DRM | | | | | 24.76 | 33.00 |
| Totals | 89.53 | 100 | 104.25 | 100 | 75.02 | 100 |
| Molar amounts - | 0.64 | 0.33 | 0.63 | 0.68 | 0.63 | 0.17 |
| NaOH & Polyol | | | | | | |

| Molar Ratios, | 1.94 | 0.93 | 3.79 |
|---|---|---|---|
| NaOH:Polyols | | | |
| Observations | Allowed to stand | Ammonia odor at | Microwaved for 210 |
| | covered with parafilm | ca. 70 seconds | seconds, yielding a |
| | overnight - moist | of microwaving, | soft-white solid. |
| | looking white amorphous | then stopped | |
| | hygroscopic solid. | heating. | |
| | Microwaved for | | |
| | 490 seconds. | | |

The exemplary premixes and formulations using alkanolamines use the highly alkaline solvents monoethanolamine (MEA), diethanolamine (DEA), and triethanolamine (TEA). The ethanolamines react with the sodium hydroxide (50%) as follows (for MEA):

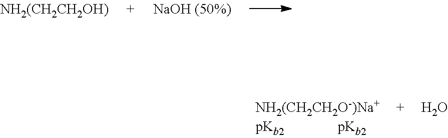

The formed solids have two strongly alkaline functional groups (two pK_{b}'s): pK_{b1} about −2 and pK_{b2} about 4.5. The premixes and formulations using alkanolamines yielded the most favorable solid compositions as described in the observations.

### Example 2

An exemplary alkoxide premix made with a derivative of glycerol-glycerol formula—is shown in Table 3.

TABLE 3

| | Alkoxides prepared from Glycerol Formal | | | | | | | |
|---|---|---|---|---|---|---|---|---|
| | (instead of Glycerol Formate) | | | | | | | |
| | 15 | | 16 | | 17 | | 18 | |
| Description | Wgt., g | Wgt., % | Wgt., g | Wgt., % | Wgt., g | Wgt., % | Wgt., g | Wgt., % |
| Sodium Hydroxide 50% | 25.39 | 42.90 | 25.18 | 91.36 | 25.25 | 85.42 | 25.36 | 79.35 |
| Glycerol Formal | 33.8 | 57.10 | 2.38 | 8.64 | 4.31 | 14.58 | 6.60 | 20.65 |
| Totals | 59.19 | 100 | 27.56 | 100 | 29.56 | 100 | 31.96 | 100 |
| Molar amounts - | 0.32 | 0.32 | 0.31 | 0.02 | 0.32 | 0.04 | 0.32 | 0.06 |
| NaOH & Polyol | | | | | | | | |
| Molar Ratios, | 0.98 | | 13.77 | | 7.62 | | 5.00 | |
| NaOH:Polyols | | | | | | | | |

| Observations | Did not form a | Continuous soft solid, | Continuous soft solid, | Continuous Solid, |
|---|---|---|---|---|
| | solid - viscous, | slightly moist | slightly moist | slightly drier, |
| | tannish-brown | | | harder than 3 & 4 |
| | liquid. | | | above. |

The premixes using glycerol formal yielded continuous solids having varying hardness as follows: softest to hardest solids were Formulas 15<16<17<18. The most favorable solid compositions had less than 57 wt-% glycerol formal. The tests show the solids made with a molar ratio of the alkali metal hydroxide to polyol greater than about 1:1 yielded solid compositions.

### Example 3

Further exemplary alkoxide premixes made with Augeo solvents are shown in Table 4.

TABLE 4

| | Alkoxides prepared from Augeo | | | |
|---|---|---|---|---|
| | Solvents from Solvay | | | |
| | 19 | | 20 | |
| Description | Wgt., g | Wgt., % | Wgt., g | Wgt., % |
| Sodium Hydroxide 50% | 25.06 | 69.34 | 25.21 | 25.09 |
| Augeo Clean Multi | 11.08 | 30.66 | | |
| Augeo Clean Plus | | | 75.25 | 74.91 |
| Totals | 36.14 | 100 | 100.46 | 100 |
| Molar amounts - NaOH & Polyol | 0.31 | 0.06 | 0.32 | 0.57 |

| Molar Ratios, NaOH:Polyols | 4.86 | 0.55 |
|---|---|---|
| Observations | Brownish-orange | Did not solidify. |
| | soft, continuous | |
| | solid | |

The premixes using the different solvents yielded a continuous solid for the Augeo Clean Multi solvent. These tests also show the solids made with a molar ratio of the alkali metal hydroxide to polyol greater than about 1:1 yielded solid compositions.

### Example 4

Exemplary alkoxide premixes made with hexylene glycol, a polyol with 6 carbons and 2 hydroxyl groups, are shown in Table 5 including observations of the formed solids. The hydroxide to water ratio as well as the molar ratio of hydroxide to polyol were calculated.

TABLE 5

| | EXP 1 | EXP 2 | EXP 3 | EXP 4 | EXP 5 | EXP 6 |
|---|---|---|---|---|---|---|
| | mass (g) | mass (g) | mass (g) | mass (g) | mass (g) | mass (g) |
| 50% | 30 | 30 | 30 | 25 | 20 | 10 |
| Caustic | | | | | | |
| Hexylene | 5 | 10 | 20 | 25 | 30 | 30 |
| Glycol | | | | | | |
| NaOH:H2O | 50:50 | 50:50 | 50:50 | 50:50 | 50:50 | 50:50 |
| wt Ratio | | | | | | |
| Molar Ratio | 17.73 | 8.86 | 4.43 | 2.95 | 1.97 | 0.98 |
| NaOH:Polyol | | | | | | |
| Notes | Soft - gel | Hard solid | Hard solid | Hard solid | Hard solid | Hard solid |
| | like solid | at RT, 50 C. | at RT, 50 C. | at RT, 50 C. | at RT, 50 C. | at RT, 50 C. |
| | * Turns light | over stability - | over stability - | over stability - | over stability - | over stability - |
| | yellow/brown | slightly soft | Hard solid | Hard Solid | slightly soft | soft |
| | color | * Turns light | * Turns | * Turns | * Turns light | * Turns light |
| | | yellow/brown | orange/brown | orange/brown | orange/brown | yellow/brown |
| | | color | color | color | color | color |

### Example 5

Exemplary solid compositions made with D-sorbitol, a polyol with 6 carbons and 6 hydroxyl groups, were evaluated as an alternative polyol to form cast solids. Cast quality of these three examples were soft/semi-contiguous solids.

TABLE 6

| | D-Sorbitol Based Formulations | | | | | |
|---|---|---|---|---|---|---|
| | 21 | | 22 | | 23 | |
| Description | Wgt., % | | Wgt., % | | Wgt., % | |
| Sodium Hydroxide 50% | 27.72 | | 28.00 | | 20.30 | |
| Nalco DVS3C008 (Phosphinic acid, | 3.02 | | | | 2.99 | |
| sodium salt) 40% | | | | | | |
| Acusol 448 | 7.94 | | | | 8.04 | |
| Acusol 445ND | | | 4.07 | | | |
| Sodium Aluminate 45% | <1 | | <1 | | 3.01 | |
| Pluronic 25-R-2 | 0.99 | | 1.01 | | 1.00 | |
| Surfonic LD-097 (26%, 30%; EO & | 2.48 | | 2.55 | | 2.51 | |
| PO, respectively). | | | | | | |
| Sodium Xylene Sulfonate 96% | 3.96 | | | | 3.01 | |
| Dissolvine DZ | 3.06 | | 4.07 | | 4.24 | |
| Sodium Carbonate | 39.60 | | 42.02 | | 43.71 | |
| D-Sorbitol 70% | 8.01 | | 15.00 | | 8.02 | |
| Esperase 6.0T | 2.99 | | 3.06 | | 3.16 | |
| Total | 100 | | 100 | | 100 | |
| Moles - NaOH (initial) and D- | 0.35 | 0.031 | 0.35 | 0.058 | 0.25 | 0.031 |

| | | | |
|---|---|---|---|
| Sorbitol | | | |
| Molar Ratio NaOH (initial):D- | 11.3 | 6.0 | 8.1 |
| Sorbitol | | | |
| Caustic wt % After Neutralization | 11.36% | 11.50% | 7.65% |
| Water wt % After Neutralization | 23.15% | 19.75% | 21.00% |
| Caustic:Water Ratio | 32.9:67.1 | 36.8:63.2 | 26.7:73.3 |

The variations reagent ratios were calculated as well as the wt-% of caustic and water after neutralization were calculated. The evaluated formulations D-Sorbitol as the polyol solidified at a lower caustic:water weight ratio as shown in Table 6 (ratio down to about 27:73 caustic:water weight ratio). As a result, the caustic:water weight ratio for D-Sorbitol is lower than exemplary glycols and glycerin producing solids from about 50:50 to about 75:25, or 60:40 to about 70:30. Examples 5 and 6 illustrate that the total carbons and hydroxyl groups in a polyol impact alkoxide based solidification. In the case with hexylene glycol, 6 carbons and 2 hydroxyl group promote precipitation. In the case of D-Sorbitol, the 6 hydroxyl groups promote hydrogen bonding. Both precipitation and hydrogen bonding enhance solidification of the overall composition.

### Example 6

Exemplary solid machine warewash compositions made with the in situ caustic solidification using propylene carbonate versus propylene glycol are shown in Tables 7A-7B. The weight ratio and molar ratios of reagents were calculated.

TABLE 7A

| | Solid warewash formulations made from caustic and | |
|---|---|---|
| | polyol make harder cast and pressed solids with | |
| | decreased caustic beads | |
| | 24 | |
| Description | Wgt., g | Wgt., % |
| Sodium Hydroxide 50% | 21.99 | 21.82 |
| Propylene glycol | 20.89 | 20.72 |
| Remainder Solid inline detergent (27.181%) | 27.77 | 27.55 |
| Caustic beads | 30.15 | 29.91 |
| Totals | 100.80 | 100 |

| | |
|---|---|
| Weight ratio of NaOH:water | 67.2:32.8 |
| Molar Ratio - NaOH:Polyol | 3.84 |

TABLE 7B
Formula 25 Propylene Carbonate based example;
Solid warewash formulations made from cyclic
carbonates and NaOH 50% and no Caustic Beads.

| Description | Wgt., g | Wgt., % |
|---|---|---|
| Sodium Carbonate | 48.29 | 47.95 |
| Propylene Carbonate | 14.45 | 14.35 |
| Sodium Hydroxide 50% | 10.38 | 10.31 |
| Remainder Solid inline detergent | 27.59 | 27.40 |
| (27.181%) | | |
| | 100.71 | 100 |
| Moles - NaOH (initial) & Propylene | 0.13 | 0.14 |
| Carbonate | | |

| | |
|---|---|
| Molar Ratio - NaOH:Propylene Carbonate | 0.92 |

Formula 24 uses the reaction of a molar ratio of propylene glycol with 50% caustic and requires 29.91% caustic beads for adequate solidification. This requirement is two folded; first, caustic beads are required to drive the formation of propylene glycoxide forward; and second, caustic beads are required to soak up water (forming caustic monohydrate solid) from the reaction and from all other ingredients. However, formula 25 using propylene carbonate does not require the use of caustic beads in the solid composition. The end result is that sodium carbonate (ash), which is far less expensive, can be used to soak up water and to form ash monohydrate with the rest of the ingredients.

### Example 7

The use of higher active caustic liquid for the control of equilibrium/kinetics of solidification of caustic solids was further evaluated. The initial examples demonstrate a complex equilibrium and kinetics of solidification using glycols. In some controlled reactions, fractions of propylene glycol were slowly and sequentially added to a fixed volume of 50% NaOH with mixing to obtain to a 1:1 molar ratio. The observations are described in Table 8.

TABLE 8

| Molar ratio of NaOH to | |
|---|---|
| propylene glycol | Observation |
| Around 10:1 to 5:1 | Rapid formation of “large slabs/chunks” |
| | of solids. |
| | Exotherm reaction. |
| | These chunks of solids can be broken to |
| | smaller pieces by mixing. |
| Middle stages | The solids start to re-dissolve. |
| 1:1 final point | Viscous liquid. |
| | Upon sitting for a long duration, such as |
| | overnight, the composition gradually |
| | solidifies. |

Without being limited to a particular mechanism of action, the use of higher active caustic liquid for the solidification of the caustic results in a more rapid and complete solidification initially according to Le Chatelier's principle. As the sodium hydroxide is used up in the equilibrium, the reaction slows down and does not go to completion. At some point, there is not enough caustic activity to insolubilize the propylene glycol to facilitate the solidification—here, propylene glycoxide. The propylene glycol becomes more soluble and can re-dissolve the formed propylene glycoxide (see Table at middle stages). At the final point of about 1:1 molar ratio, as the remaining propylene glycol in reaction is allowed to sit for a long time (e.g. overnight) the viscous liquid solidifies slowly, caustic activity goes up and reaction is driven towards completion.

Using Le Chatelier's principal, the reaction can be driven towards completion by using higher active caustic liquid, such as 70% NaOH (which is a liquid ≥149° F. and within cast solid manufacturing conditions). Formula 24 (Table 10A in Example 6) ends up with 21.82% NaOH (50%) and 29.91 caustic beads. A large part of the beads was used in solidifying the remaining detergent, however there were still left-over beads to drive the formation of propylene glycoxide.

A higher activity of caustic, such as 70% NaOH, allows a more rapid solidification with the evaluated glycols compared to the commercially available caustic liquid (50% NaOH) (as a replacement for caustic beads (100% NaOH)). However, in the less concentrated actives of NaOH, when using only glycol (ethylene glycol, propylene glycol, hexylene glycol, glycerin, etc.) a combination of caustic beads and caustic liquid to achieve higher activity may be preferred. However, as the % active NaOH is increased the reaction is driven further to completion and a more homogenous solid is produced.

### Example 9

Analysis of polyol (glycol)-based solid compositions using oven storage conditions to assess solid stability and melting points was conducted. The formulations were stored in an oven at 150° F. (65° C.) in closed containers and visual assessments of the oven-measured melting were made. The various % components, mol % and ratios of reagents were calculated.

The results are shown in Table 9.

TABLE 9

| | | | | | | | % Beads | | | | | | | |
|---|---|---|---|---|---|---|---|---|---|---|---|---|---|---|
| | | | Mole % | | | | left after | | | | | | | Oven |
| | | | caustic | | | | neutral- | Mole % | | | | | mol % | Storage |
| | | % | from | | | % | ization | caustic | | | Total | | Caustic: | Results |
| Formu- | | caustic | caustic | % | Mole % | Caustic | of | from | Ash | Ash | mol % | Mol % | mol % | Closed |
| lation | Polyol | liquid | liquid | Polyol | Polyol | Beads | polymers | beads | (%) | (mol %) | Caustic | water | Polyol | Containers |
| 5 | Ethylene | 11.91 | 0.149 | 9.23 | 0.149 | 30.24 | 27.74 | 0.694 | 21.26 | 0.20 | 0.84 | 0.89 | 5.66 | Hard |
| | Glycol | | | | | | | | | | | | | solid |
| 7 | Ethylene | 12.15 | 0.152 | 9.27 | 0.149 | 30.12 | 27.62 | 0.691 | 21.13 | 0.20 | 0.84 | 0.90 | 5.64 | Hard |
| | Glycol | | | | | | | | | | | | | solid |
| 8 | Ethylene | 18.94 | 0.24 | 2.11 | 0.03 | 30.42 | 27.92 | 0.70 | 21.06 | 0.20 | 0.93 | 1.09 | 27.54 | Melted |
| | Glycol | | | | | | | | | | | | | |
| 2 | Glycerin | 10.98 | 0.137 | 10.35 | 0.112 | 29.90 | 27.40 | 0.685 | 21.33 | 0.20 | 0.82 | 0.87 | 7.32 | Soft |
| | | | | | | | | | | | | | | solid |
| 3 | Glycerin | 17.17 | 0.215 | 4.71 | 0.051 | 30.20 | 27.70 | 0.693 | 21.15 | 0.20 | 0.91 | 1.04 | 17.75 | Melted |
| 4 | Glycerin | 19.05 | 0.238 | 2.28 | 0.025 | 30.20 | 27.70 | 0.693 | 21.01 | 0.20 | 0.93 | 1.09 | 37.55 | Melted |
| 9 | Hexylene | 11.89 | 0.149 | 8.78 | 0.074 | 30.10 | 27.60 | 0.690 | 21.03 | 0.20 | 0.84 | 0.89 | 11.29 | Melted |
| | Glycol | | | | | | | | | | | | | |
| 0 | Hexylene | 15.43 | 0.193 | 5.69 | 0.048 | 30.28 | 27.78 | 0.695 | 21.35 | 0.20 | 0.89 | 0.99 | 18.43 | Melted |
| | Glycol | | | | | | | | | | | | | |
| 1 | Hexylene | 17.93 | 0.224 | 3.53 | 0.030 | 30.18 | 27.68 | 0.692 | 21.11 | 0.20 | 0.92 | 1.06 | 30.67 | Melted |
| | Glycol | | | | | | | | | | | | | |
| 2 | Hexylene | 18.77 | 0.235 | 2.76 | 0.023 | 29.76 | 27.26 | 0.682 | 21.13 | 0.20 | 0.92 | 1.08 | 39.27 | Melted |
| | Glycol | | | | | | | | | | | | | |

The evaluated compositions show the solids having a molar ratio of the alkali metal hydroxide to polyol is between about greater than about 1:1 and about 10:1, and further showing the importance of keeping the overall after reaction molar caustic to water ratio of 1:1.

### Example 10

Further analysis of the evaluated compositions were conducted. The compositions were prepared and placed in an oven (66° C.) to assess melting conditions after the solidification of the compositions. The formulations were stored in an oven at 150° F. (65° C.) in closed containers and visual assessments of the oven-measured melting were made. The mol % and ratios of reagents were calculated.

The formulations shown in Table 10 compare the glycerin (polyol) formulations in prior Example compared to additional composition formulations using 95% and 85% crude glycerins used to solidify caustic compositions in an inline machine ware wash formulation. The compositions modifying an inline formulation are shown in Tables 11-14.

TABLE 10

| | | | | | | | % Beads | |
|---|---|---|---|---|---|---|---|---|
| | | | Mole % | | | | left after | |
| | | | caustic | | | | neutral- | Mole % |
| | | % | from | | | % | ization | caustic |
| Formu- | | caustic | caustic | % | Mole % | Caustic | of | from |
| lation | Polyol | liquid | liquid | Polyol | Polyol | Beads | polymers | beads |
| 2 | Glycerin | 10.98 | 0.137 | 10.35 | 0.112 | 29.90 | 27.40 | 0.685 |
| 3 | Glycerin | 17.17 | 0.215 | 4.71 | 0.051 | 30.20 | 27.70 | 0.693 |
| 4 | Glycerin | 19.05 | 0.238 | 2.28 | 0.025 | 30.20 | 27.70 | 0.693 |
| Inline | Crude | 21.20 | 0.265 | 15.75 | 0.162 | 35.80 | 33.30 | 0.833 |
| (minus 0.5% | Glycerin | | | | | | | |
| soft water) - | 95% | | | | | | | |
| Table 15 | | | | | | | | |
| Inline | Crude | 21.20 | 0.265 | 15.75 | 0.162 | 35.80 | 33.30 | 0.833 |
| (minus 0.5% | Glycerin | | | | | | | |
| soft water; | 95% | | | | | | | |
| 3.24% ash | | | | | | | | |
| replacing | | | | | | | | |
| sodium | | | | | | | | |
| sulfate) - | | | | | | | | |
| Table 16 | | | | | | | | |
| Inline | Crude | 21.20 | 0.265 | 17.30 | 0.160 | 35.80 | 33.61 | 0.840 |
| (Acusol 448 | Glycerin | | | | | | | |
| reduced to | 85% | | | | | | | |
| 7%) - Table | | | | | | | | |
| 17 | | | | | | | | |
| Inline | Crude | 22.30 | 0.279 | 15.20 | 0.140 | 35.80 | 33.93 | 0.848 |
| (Acusol 448 | Glycerin | | | | | | | |
| reduced to | 85% | | | | | | | |
| 6%) - Table | | | | | | | | |
| 18 | | | | | | | | |

| | | | | | | Oven |
|---|---|---|---|---|---|---|
| | | | | | | Storage |
| | | | | | | Results |
| | | | Total | | mol % | Closed |
| Formu- | Ash | Ash | mol % | Mol % | Caustic:mol | Contain- |
| lation | (%) | (mol %) | Caustic | water | % Polyol | ers |
| 2 | 21.33 | 0.20 | 0.82 | 0.87 | 7.32 | Soft |
| | | | | | | solid |
| 3 | 21.15 | 0.20 | 0.91 | 1.04 | 17.75 | Melted |
| 4 | 21.01 | 0.20 | 0.93 | 1.09 | 37.55 | Melted |
| Inline | sodium | | 1.10 | 1.12 | 6.76 | Less |
| (minus 0.5% | sulfate | | | | | soft |
| soft water) - | | | | | | solid |
| Table 15 | | | | | | |
| Inline | 3.24 | 0.03 | 1.10 | 1.12 | 6.76 | Less |
| (minus 0.5% | | | | | | soft |
| soft water; | | | | | | solid |
| 3.24% ash | | | | | | |
| replacing | | | | | | |
| sodium | | | | | | |
| sulfate) - | | | | | | |
| Table 16 | | | | | | |
| Inline | 2.77 | 0.03 | 1.11 | 1.12 | 6.92 | Soft |
| (Acusol 448 | | | | | | solid |
| reduced to | | | | | | |
| 7%) - Table | | | | | | |
| 17 | | | | | | |
| Inline | 4.77 | 0.05 | 1.13 | 1.11 | 8.03 | Soft |
| (Acusol 448 | | | | | | solid |
| reduced to | | | | | | |
| 6%) - Table | | | | | | |
| 18 | | | | | | |

TABLE 11

| RM | wt % |
|---|---|
| NaOH 50% | 20-25 |
| Crude glycerin | 15-20 |
| (95%) | |
| Soft water | <1 |
| Sodium | 5-10 |
| gluconate | |
| Sodium | <1 |
| aluminate | |
| PSO | 5-10 |
| Pluronic N3 | <1 |
| Hexylene glycol | <1 |
| Acusol 448 | 5-10 |
| Sodium sulfate | 1-5 |
| Caustic bead | 35-38 |
| Total | 100 |
| Total Water % | 20.84% |
| (after | |
| neutralization) | |
| Total Caustic % | 43.90% |
| (after | |
| neutralization) | |
| caustic:water ratio | 67.8:32.2 |
| Solidification | Complete solid at |
| observations | room temperature |

TABLE 12

| RM | wt % |
|---|---|
| NaOH 50% | 20-25 |
| Crude glycerin | 15-20 |
| (95%) | |
| Soft water | <1 |
| Sodium gluconate | 5-10 |
| Sodium aluminate | <1 |
| PSO | 5-10 |
| Pluronic N3 | <1 |
| Hexylene glycol | <1 |
| Acusol 448 | 5-10 |
| Dense ash | 1-5 |
| Caustic bead | 35-38 |
| Total | 100 |
| Total Water % (after | 20.84% |
| neutralization) | |
| Total Caustic % | 43.90% |
| (after neutralization) | |
| caustic:water ratio | 67.8:32.2 |
| Solidification | Complete solid at |
| observations | room temperature |

TABLE 13

| RM | wt % |
|---|---|
| NaOH 50% | 20-25 |
| Crude glycerin | 15-20 |
| (85%) | |
| Soft water | <1 |
| Sodium gluconate | 5-10 |
| Sodium aluminate | <1 |
| PSO | 5-10 |
| Pluronic N3 | <1 |
| Hexylene glycol | <1 |
| Acusol 448 | 5-8 |
| Dense Ash | 1-3 |
| Caustic bead | 35-38 |
| Total | 100 |
| Total Water % | 22.01% |
| (after | |
| neutralization) | |
| Total Caustic % | 44.20% |
| (after | |
| neutralization) | |
| caustic:water ratio | 66.7:33.3 |
| Solidification | Complete solid at |
| observations | room temperature |

TABLE 14

| RM | wt % |
|---|---|
| NaOH 50% | 20-25 |
| Crude glycerin | 15-18 |
| (85%) | |
| Soft water | <1 |
| Sodium | 5-8 |
| gluconate | |
| Sodium | <1 |
| aluminate | |
| PSO | 5-10 |
| Pluronic N3 | <1 |
| Hexylene glycol | <1 |
| Acusol 448 | 5-8 |
| Dense Ash | 3-8 |
| Caustic bead | 35-38 |
| Total | 100 |
| Total Water % | 21.60% |
| (after | |
| neutralization) | |
| Total Caustic % | 45.07% |
| (after | |
| neutralization) | |
| caustic:water ratio | 67.6:32.4 |
| Solidification | Complete solid at |
| observations | room temperature |

Also observed is that higher melting solids (e.g. those greater melting points than Inline Machine Warewash Detergent) are readily obtainable with 95% or even 85% crude glycerin. These allow a substantial reduction in the usage of caustic beads (100% NaOH). This reduction in caustic beads will vary based on the glycol used (i.e. polyol or alkylene carbonate) for the solidification.

The use of glycerin carbonate can also be achieved after synthesizing the glycerin carbonate from inexpensive raw materials, namely crude glycerin. This is an added benefit to the methods of making the solid compositions as the reagent can be produced from a waste stream of biofuel production to beneficially reuse a waste stream and provide an inexpensive raw material. As described herein, both embodiments using solidification with crude glycerin as well as solidification with glycerin carbonate provide suitable pathways to forming the solid compositions.

### Example 11

Solid composition machine ware washing tests were conducted using the formulations in Tables 15-17 (Formulas 3-5, respectively). These were compared to a Commercial Product A formula, a caustic solid warewash detergent. Performance of each formula was assessed using three separate test methods: a 10, 50, or 100 cycle test. The 10 cycle test is designed to assess the ability of the formulation to both clean and prevent redeposition of protein soils on glass and plastic ware in an ADW application. In this test, a total of 12 glasses and 4 plastic tumblers are arranged in a dishmachine rack such that the left and right side of the rack mirror each other. The wares on the left side of the rack are coated in a protein heavy soil and then baked in an oven to cure the soil onto the ware. The ware on the right side of the rack remains untouched throughout the course of the test and is present to measure redeposition of soil. After baking on the soil, all ware is washed in a high temp dishmachine using the test formulation at the desired concentration. This process is repeated ten times and then ware is visually analyzed for the appearance of spots and film. Less spotting and filming indicates a better performing detergent. Each piece of ware is then stained using Coomassie Blue to visualize the amount of protein remaining on the ware. Less stain coverage indicates a better performing detergent.

The 50 cycle test is designed to test the ability of a detergent formulation to prevent food soil suspended in the sump of a high temperature dishmachine from redepositing on clean ware. In this test, six clean glasses and one clean plastic tumbler are arranged in a dishmachine rack and washed 50 times in a high temperature dishmachine that contains 4000 ppm of a protein-rich food soil blend suspended in the sump. Following the test, the ware is visually analyzed for the appearance of spots and film. Less spotting and filming indicates a better performing detergent. Each piece of ware is then stained using Coomassie Blue to visualize the amount of protein on the ware. Less stain coverage indicates a better performing detergent.

The 100 cycle test is designed to test the ability of a formulation to control inorganic scale buildup on glass and plastic ware in the presence of hard water in an ADW application. Six glasses and one plastic tumbler are arranged in a dishmachine rack and washed in a high temp dishmachine a total of 100 times using a desired concentration of the test formulation in hard water (17 grains per gallon). Upon completion of the test, glasses are evaluated for scale accumulation both visually and by using image analysis. A lower opacity value in the image analysis indicates a better performing detergent.

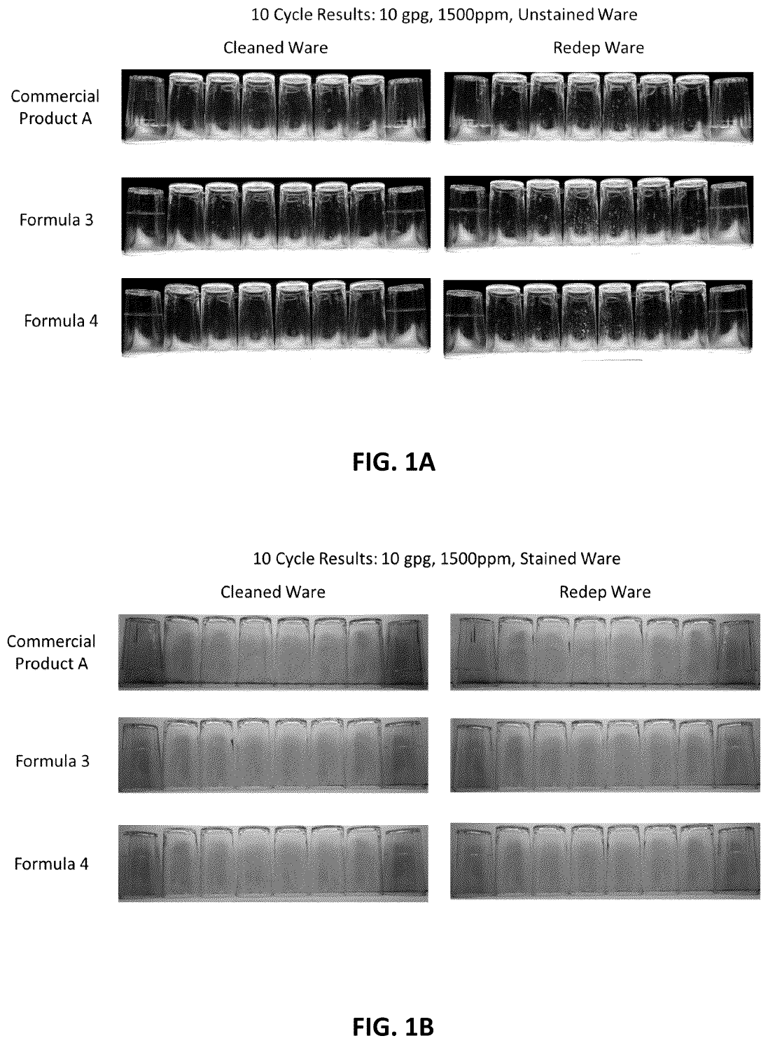

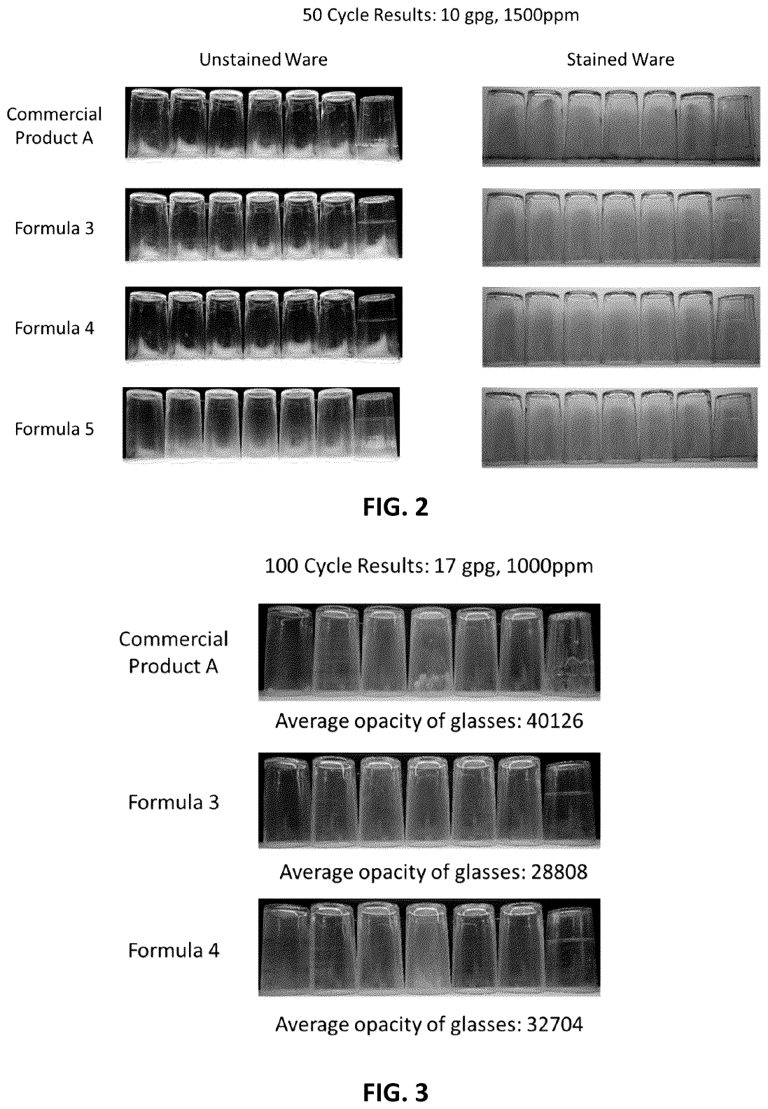

The results are shown in FIGS. 1-3. FIG. 1A and 1B show the results of 10 cycle tests run in 10 gpg water using 1500 ppm of the test formulation before staining with Coomassie Blue using unstained ware and stained ware, respectively. In this test, both Formula 3 and Formula 4 show comparable results to Commercial Product A for spotting and filming. In a similar manner, after the ware is stained (FIG. 3), similar results are seen for all three detergents. FIG. 2 shows the results of 50 cycle tests comparing the performance of Formulas 3, 4, and 5 to Commercial Product A. Formula 3 shows similar spotting and filming performance to Commercial Product A, while Formula 4 shows superior performance, and Formula 5 shows worse performance. All three formulations show superior protein performance to commercial product A, as seen by the stained ware photos. FIG. 3 demonstrates that Formula 3 and Formula 4 show improved performance in the 100 cycle test over Commercial Product A (lower average opacity). The warewash results shown in these figures demonstrate that alkoxide based solid formulations can be made that show equivalent or superior performance to current commercial products.

TABLE 15
(Formula 3)

| Description | Wt-Percent |
|---|---|
| NaOH 50% | 25-30 |
| Nalco polymer | 15-18 |
| Crude Glycerin 85% | 15-18 |
| Soft water | <1 |
| Sodium aluminate | <1 |
| Pluronic N3 | <1 |
| Hexylene glycol | <1 |
| Dense Ash | 5-8 |
| Caustic bead | 35-40 |
| Total | 100 |

TABLE 16
(Formula 4)

| Description | Wt-Percent |
|---|---|
| NaOH 50% | 25-30 |
| PSO | 5-10 |
| Nalco polymer | 10-15 |
| Crude Glycerin 85% | 12-15 |
| Soft water | <1 |
| Sodium aluminate | <1 |
| Pluronic N3 | <1 |
| Hexylene glycol | <1 |
| Dense Ash | 5-8 |
| Caustic bead | 35-40 |
| TOTAL | 100 |

TABLE 17
(Formula 5)

| Description | Percent |
|---|---|
| NaOH 50% | 20-25 |
| Sodium gluconate | 5-10 |
| Nalco polymer | 10-15 |
| Crude Glycerin 85% | 10-15 |
| Soft water | <1 |
| Sodium aluminate | <1 |
| Pluronic N3 | <1 |
| Hexylene glycol | <1 |
| Dense Ash | 5-8 |
| Caustic bead | 35-40 |
| TOTAL | 100 |

### Example 12

An example formulation that is free of caustic beads was evaluated. An aliquot of the following formula in Table 18 was placed in an oven for approximately 24 hours at approximately 67° C. No melting or dimension changes were noted, indicating a high melting continuous solid. The molar ratios of reagents were calculated.

TABLE 18
Sample 2

| Description | Wgt., g | Wgt., % |
|---|---|---|
| NaOH 50% | 8.68 | 34.65 |
| Commercial Product A Remaining Components | 2.38 | 9.50 |
| Premix | | |
| Sodium Gluconate (88.82%) | | 8.44 |
| Soft Water (0.00%) | | 0.00 |
| Sodium Aluminate 45% (2.45%) | | 0.23 |
| Propoxy-Ethoxy N 3% (8.73) | | 0.83 |
| Acusol 448 | 2.25 | 8.98 |
| Hexylene Glycol | 0.04 | 0.16 |
| Sodium Carbonate, anhyd. | 8.65 | 34.53 |
| Glycerol Carbonate (InKemia Green Chemicals) | 3.05 | 12.18 |
| | 25.05 | 100 |
| Moles - NaOH & Glycerol Carbonate (Left & | 0.109 | 0.026 |
| Right, respectively) | | |

| | |
|---|---|
| Molar Ratio - NaOH:Glycerol Carbonate | 4.20 |

### Example 13

The solid composition in Table 19 was compared to a Commercial Caustic Bead Control formulation (also Table 19) to assess processing differences as a result of reducing the caustic bead concentration (nearly 40% in Formula A). The Commercial Control formulation requires a chiller (chilling step) during the hydration of the caustic beads due to the exothermic reaction. The use of solidification methods using the composition in Formula A (having reduced caustic bead concentration) was evaluated for beneficial processing changes from differences in the exotherm of the solids.

Temperatures were measured by a thermocouple placed on the interior of the capsule. The experiment setup measures temperatures going from outer to inner layers to determine the whole capsule profile. As referred to herein the capsule is the container within which the composition solidifies and thereafter is dispensed from the same solid capsule (i.e. contained within a plastic container from which the solid is dispensed upon being contacted with a water source to create a concentrate and/or use solution for dispensing).

For processing of the Commercial Control formulation, the temperature in the capsule required for solidification is less than about 125° F. This requires use of a chiller (0° F. chiller is used in the solidification process) and can still take approximately 60 minutes from exiting the chiller for a capsule temperature to decrease below about 125° F. for solidification. Notably for both the Commercial Control and Formula A an equivalent size capsule was made. Approximately 4 kg capsules (containers wherein the formulations are solidified) were made and provides a direct cooling profile comparison. As a result, only the chemistry characteristics impact the temperature and times.

TABLE 19

Wt-Percent

| | Formula A | |
|---|---|---|
| | (reduced | Commercial |
| Description | caustic bead) | Control |
| NaOH 50% | 22-25 | 15-20 |
| Sodium gluconate | 0 | 5-10 |
| PSO | 1-5 | 5-8 |
| Polymers | 15.00 | 8.00 |
| Soft water | <1 | 0 |
| Nonionic block | <1 | <1 |
| copolymers | | |
| Caustic bead | 35-38 | 50-55 |
| Sodium sulfate | 0 | 5-10 |
| Dense ash | 5-8 | 0 |
| Crude Glycerin 85% | 10-15 | 0 |
| Additional agents | Remainder | Remainder |
| (Hexylene glycol, sodium | | |
| aluminate) | | |
| TOTAL | 100 | 100 |

The core temperature of the capsule for the Commercial Control and Formula A were measured. For Commercial Control even after leaving a chiller the temperature was about 135° F. when dispensed into the capsule (still above the solidification temperature of about 125° F. to ensure that the composition does not solidify before it is contained in the capsule), thereafter requiring additional time for the temperature to decrease in order for solidification to take place. When monitored the Commercial Control capsule required about 5 hours' time for the interior temperature to decrease to less than 125° F. (time for the core to solidify), demonstrating the required use of the chiller for the solidification of the capsules containing Commercial Control.

In contrast the solid composition of Formula A resulted in a beneficial increase in the solidification temperature of the capsule at about 150-155° F. Without being limited to a particular mechanism of action, the increase melting point of the solid composition provides for an increased solidification temperature for the solid. In addition, the internal temperature of Formula A measured quickly decreased below the solidification temperature without the use of a chiller or chilling step. In embodiments, the internal temperature decreased below the solidification temperature within about 1 hour. In comparison, the core temperature of Formula A even decreased to less than 125° F. (the significantly lower solidification temperature for the Commercial Control) within about three hours (compared to over five hours required for Commercial Control without chilling step).

The testing confirmed that Formula A provided a more balanced exothermic reaction in forming the solid composition. Without being limited to a particular mechanism of action, the Formula A having reduced caustic bead concentration exhibits a slowing down of dissolution of the caustic beads to provide a more controlled exotherm. Formula A provides a semi-solid to solid state which slows down the dissolution of the caustic beads (i.e. hydration of caustic beads to solidify) and provides the controlled exotherm. As a result of these differences in the solid does not require a chiller step as required for the Commercial Control, providing a significant processing benefit for the solidification methods described herein using caustic and either a polyol reagent or an alkylene carbonate.

### Example 14

Additional formulations evaluated are shown in Tables 20-22 and provide stable solid compositions for various applications of use. The moles and molar ratios of reagents were calculated.

TABLE 20

| Components | Formula 6 |
|---|---|
| Water Soft | 10-15 |
| Disodium HEDP Salt DRM | <1 |
| Trisodium HEDTA Liquid | 1-3 |

38%

| Citric Acid, 50% white | 5-8 |
|---|---|
| Polyacrylic acid 46% | <1 |
| Sodium Hydroxide 50% Liquid | 1-5 |

Bulk

| Isononanoic Acid, Sodium Salt | 1-3 |
|---|---|
| Dense Soda Ash | 5-10 |
| Water Soft | 5-10 |
| Dense Soda Ash | 1-5 |
| Glycerol Carbonate | <1 |
| Dense Soda Ash | 45-50 |
| Linear Alcohol (C12-C16) 7EO | 1-5 |
| LAS 90% | 1-3 |
| Additional functional | Remainder |

ingredients (fragrance, enzyme,

| dye, antifoaming silicone) | |
|---|---|
| Totals | 100 |

| | | |
|---|---|---|
| Moles NaOH (initial) and | 0.049 | 0.005 |
| Polyol | | |

| | |
|---|---|
| Molar Ratio NaOH (initial):Polyol | 9.8:1 |

TABLE 21
Formula 7

| Description | Wgt., % |
|---|---|
| Sodium Hydroxide 50% | 10-12 |
| Sodium Gluconate Granular | 5-10 |
| Soft Water | <1 |
| Nalco DVS3C008 (Phosphinic acid, sodium | 5-8 |
| salt) | |
| Acusol 448 | 5-10 |
| Sodium Carbonate | 45-50 |
| Propylene Carbonate | 15-20 |
| Additional functional ingredients | Remainder |
| Totals | 100 |
| NaOH (initial):Propylene Carbonate | 0.71:1 |
| Molar Ratio (Excess Propylene Carbonate) | |

Very hard continuous solids

TABLE 22
Formula 8

| Description | Wgt., % |
|---|---|
| Sodium Hydroxide 50% | 20-25 |
| Nalco DVS3C008 (Phosphinic acid, sodium | 1-5 |
| salt) | |
| Additional Polymer (EXP000929 (Batch | 5-10 |
| XC9B1410)) | |
| Propoxy-Ethoxy N-3 | <1 |
| Soft Water | 5-10 |
| Sodium Xylene Sulfonate 96% | 5-8 |
| Sodium Carbonate | 40-45 |
| Glycerol Carbonate | 5-10 |
| Additional functional ingredients | Remainder |
| Totals | 100 |
| NaOH (initial):Glycerol Carbonate Molar | 3.88:1 |
| Ratio | |

Firm/hard continuous solids - scaled up at Pilot Plant

### Example 15

A formulation as shown in TABLE 23 was prepared to compare to Control as shown in TABLE 24. The weight ratios and % reagents and resulting components in the solids were calculated.

TABLE 23
Composition B

| RM | wt % |
|---|---|
| NaOH 50% | 22.3 |
| Crude glycerin (85%) | 15.2 |
| Soft water | <1 |
| Sodium gluconate | 5-10 |
| Sodium aluminate | <1 |
| PSO | 5-10 |
| Pluronic N3 | <1 |
| Hexylene glycol | <1 |
| Acusol 448 | 5-10 |
| Dense Ash | 4.77 |
| Caustic bead | 35.8 |
| Total Water % (after | 21.60% |
| neutralization) | |
| Total Caustic % (after | 45.07% |
| neutralization) | |
| caustic:water ratio | 67.6:32.4 |
| Observation | Complete |
| | Solid |

TABLE 24
Control

| RM | wt % |
|---|---|
| NaOH 50% | 14.18 |
| Sodium gluconate | 5-10 |
| Sodium aluminate, | <1 |
| 45% | |
| Pluronic N3 | <1 |
| PSO | 5-10 |
| Hexylene glycol | <1 |
| Acusol 448 | 5-10 |
| Sodium sulfate | 1-5 |
| Caustic bead | 58.64 |
| Water | Remainder |
| Total Water % (after | 100 |
| neutralization) | 16.44% |
| Total Caustic % (after | 63.23% |
| neutralization) | |
| caustic:water ratio | 79.4:20.6 |

The disclosures being thus described, it will be obvious that the same may be varied in many ways. Such variations are not to be regarded as a departure from the spirit and scope of the disclosures and all such modifications are intended to be included within the scope of the following claims. The above specification provides a description of the manufacture and use of the disclosed compositions and methods. Since many embodiments can be made without departing from the spirit and scope of the disclosure. the disclosure resides in the claims.

1. A solid composition comprising:
an alkali metal hydroxide;
an organic molecule having at least one hydroxyl group; and
water;
wherein the weight ratio of the alkali metal hydroxide to water in the solid composition is from about 27:73 to about 75:25, and
wherein the composition is a contiguous solid, powder or granule.

2. The solid composition of claim 1, wherein the alkali metal hydroxide is sodium hydroxide, potassium hydroxide, lithium hydroxide, derivatives thereof, or combinations thereof, and wherein the organic molecule having at least one hydroxyl group is a polyol comprising glycol, glycerin or sorbitol.

3. (canceled).

4. (canceled).

5. The solid composition of claim 1, further comprising an anhydrous material to absorb excess water in the composition.

6. The solid composition of claim 1, wherein the weight ratio of the alkali metal hydroxide to water in the solid composition is from about 50:50 to about 75:25, or from about 60:40 to about 70:30, or wherein the molar ratio of caustic to water is about 1:2.2 to about 1:1.

7. (canceled).

8. The solid composition of claim 1, further comprising an additional functional ingredient comprising one or more of a salt, chelating/sequestering agent, alkalinity source, surfactant, detersive polymer, cleaning agent, rinse aid composition, softener, pH modifier, source of acidity, anti-corrosion agent, secondary hardening agent, solubility modifier, detergent builder, detergent filler, defoamer, anti-redeposition agent, antimicrobial, rinse aid composition, a threshold agent or system, aesthetic enhancing agent, optical brightener, lubricant, bleaching agent, enzyme, effervescent agent, or activator for an active oxygen compound.

9. (canceled).

10. The composition of claim 1, wherein the alkali metal hydroxide of the composition comprises less than about 40 wt-% solid caustic bead and/or wherein the composition has at least about 20% less solid caustic bead compared to a solid composition that does not contain the alkali metal hydroxide and organic molecule having at least one hydroxyl group forming the solid composition.

11. (canceled).

12. A method of forming the solid composition according to claim 1, comprising:
mixing the organic molecule containing at least one hydroxyl group with a liquid alkali metal hydroxide; and
either (a) forming in situ a contiguous solid composition or (b) isolating the solid as a precipitate material,
wherein the molar ratio of the alkali metal hydroxide to polyol is between about 1:1 and about 10:1, and
wherein the solid composition is formed between about 1 minute and about 3 hours, or between about 1 minute and about 20 minutes.

13. The method of claim 12, wherein the solid composition does not require the use of an additional caustic source or anhydrous source to absorb excess water, and wherein the method takes place at ambient temperature and/or does not require or employ a chiller step to lower the temperature below a solidification temperature.

14. The method of claim 12, wherein the isolated precipitate material is further dehydrated or combined with a functional anhydrous material to remove excess water, such as for use in a solid composition or as a pre-mix, and wherein the isolated precipitate material is spray dried to provide a powder or granule.

15. (canceled).

16. (canceled).

17. (canceled).

18. The method of claim 12, further comprising combining the at least one additional functional ingredient to form the solid composition and/or further comprising transferring the reagents into a container or housing before the forming in situ of the contiguous solid composition.

19. (canceled).

20. (canceled).

21. A solid composition comprising:
an alkali metal hydroxide and/or an alkali metal carbonate;
an alkylene carbonate; and
water;
wherein the molar ratio of the initial alkali metal hydroxide to alkylene carbonate combined to make the solid composition is from about 0.5:1 to about 10:1, and
wherein the composition is a contiguous solid, powder or granule.

22. The solid composition of claim 21, wherein the alkali metal hydroxide is sodium hydroxide, potassium hydroxide, lithium hydroxide, derivatives thereof, or combinations thereof, wherein the alkylene carbonate is glycerin carbonate, ethylene carbonate, propylene carbonate, or butylene carbonate.

23. (canceled).

24. The solid composition of claim 21, further comprising an anhydrous material to absorb excess water in the composition and/or an additional functional ingredient comprising one or more of a salt, chelating/sequestering agent, alkalinity source, surfactant, detersive polymer, cleaning agent, rinse aid composition, softener, pH modifier, source of acidity, anti-corrosion agent, secondary hardening agent, solubility modifier, detergent builder, detergent filler, defoamer, anti-redeposition agent, antimicrobial, rinse aid composition, a threshold agent or system, aesthetic enhancing agent, optical brightener, lubricant, bleaching agent, enzyme, effervescent agent, or activator for an active oxygen compound.

25. (canceled).

26. (canceled).

27. The composition of claim 21, wherein the alkali metal hydroxide of the composition is free of solid caustic bead and/or wherein the composition has at least about 50% less solid caustic bead compared to a solid composition that does not contain the alkali metal hydroxide and alkylene carbonate forming the solid composition.

28. (canceled).

29. A method of forming the solid composition according to claim 21, comprising:
mixing the alkylene carbonate with a liquid alkali metal hydroxide; and
either (a) forming in situ a contiguous solid composition, and optionally transferring the reagents into a container or housing before the forming in situ of the contiguous solid composition or (b) isolating the solid as a precipitate material,
wherein the molar ratio of the initial alkali metal hydroxide to alkylene carbonate is from about 0.5:1 to 10:1, and
wherein the solid composition is formed between about 1 minute and about 3 hours, or between about 1 minute and about 20 minutes.

30. The method of claim 29, wherein the solid composition does not require the use of an additional caustic source or anhydrous source to absorb excess water, and wherein the method takes place at ambient temperature and/or does not require or employ a chiller step to lower the temperature below a solidification temperature.

31. The method of claim 29, wherein the isolated precipitate material is further dehydrated or combined with a functional anhydrous material to remove excess water, such as for use in a solid composition or as a pre-mix and/or wherein the isolated precipitate material is spray dried to provide a powder or granule.

32. (canceled).

33. (canceled).

34. (canceled).

35. The method of claim 29, further comprising combining the at least one additional functional ingredient to form the solid composition, wherein the additional functional ingredient comprises one or more of a salt, chelating/sequestering agent, alkalinity source, surfactant, detersive polymer, cleaning agent, rinse aid composition, softener, pH modifier, source of acidity, anti-corrosion agent, secondary hardening agent, solubility modifier, detergent builder, detergent filler, defoamer, anti-redeposition agent, antimicrobial, rinse aid composition, a threshold agent or system, aesthetic enhancing agent, optical brightener, lubricant, bleaching agent, enzyme, effervescent agent, or activator for an active oxygen compound.

36. (canceled).

37. (canceled).

38. A method of using the composition of claim 1 or claim 21 for cleaning, disinfecting, and/or sanitizing comprising:
contacting an article or surface in need of cleaning, disinfecting, and/or sanitizing with the solid composition of claim 1 or claim 21; and
cleaning, disinfecting, and/or sanitizing the article or surface.)

39. The method of claim 38, further comprising a step of diluting the solid composition to form a use solution to contact the article or surface, and wherein the use solution is formed on-site and/or during in-situ generation of the solid composition.

40. (canceled).
